(19) United States
(12) Patent Application Publication
(10) Pub. No.: US 2026/0292538 A1
(43) Pub. Date: Sep. 24, 2026

(54) METHODS FOR HANDLING MULTIPLE ARITIFICIAL INTELLIGENCE (AI) FUNCTIONALITIES

(71) Applicant: InterDigital Patent Holdings, Inc., Wilmington, DE (US)

(72) Inventors: Moon IL Lee, Melville, NY (US); Yugeswar Deenoo Narayanan Thangaraj, Chalfont, PA (US); Patrick Tooher, Montreal (CA); Mihaela Beluri, Jericho, NY (US); Mohamed Salah Ibrahim, Chesterbrook, PA (US); Anouar Yatribi, Greater London (GB); Dylan Watts, Montreal (CA)

(73) Assignee: InterDigital Patent Holdings, Inc., Wilmington, DE (US)

(21) Appl. No.: 19/088,385

(22) Filed: Mar. 24, 2025

(51) Int. Cl. H04W 24/02; H04W 8/08

(52) U.S. Cl. CPC H04W 24/02; H04W 8/08

(57) ABSTRACT

A wireless transmit/receive unit (WTRU) may receive configuration information indicating measurement reporting information for a plurality of processes. The WTRU may determine a processing unit allocation for each process based on a minimum processing time associated with each process and/or a readiness status of each process. The WTRU may determine a processing unit availability based on the processing unit allocation, minimum processing time, a maximum number of processing units, and/or capability of the processing units. The WTRU may determine a priority order for each process. The WTRU may determine to process at least a subset of the plurality of processes based on the priority order, the processing unit availability, and/or the processing unit allocation for each process. The WTRU may send a report associated with each process of the at least subset of the plurality of processes.

### BACKGROUND

A wireless transmit/receive unit (WTRU) may report channel state information (CSI). A WTRU may be configured to report CSI aperiodically and/or periodically, and/or semi-statically. A WTRU may use one or more artificial intelligence/machine learning (AI/ML) models to perform one or more CSI measurements.

### SUMMARY

A WTRU may determine artificial intelligence/machine learning (AI/ML) processing unit (APU) availability and/or a priority order for (e.g., simultaneously) triggered AI/ML and/or non-AI/ML functionality(ies), for example, based on the determined APU availability, channel state information (CSI) processing unit (CPU) availability, and/or per-functionality/inter-functionality priority rule(s). The WTRU may determine one or more processing methods to process one or more of the (e.g., simultaneously) triggered AI/ML and/or non-AI/ML functionalities, for example, based on the priority order, APU availability, CPU availability, and/or determined APU allocation(s).

The priority order of AI/ML functionality(ies) and/or non-AI/ML functionality(ies) may be determined based on the number of APUs and/or CPUs, performance of the functionality(ies), and/or WTRU sided condition(s) (e.g., power mode, channel condition, etc.).

The required number of APUs may be determined based on timeline indicated by the network, number of AI/ML models associated with the functionality, and/or complexity (e.g., model size, flops) for the functionality and/or model.

AI/ML model readiness state (e.g., deployed in AI engine, AI engine has space and not deployed, AI engine has no space and not deployed) may be described herein and/or used to determine the required minimum processing time. The required minimum processing time may be determined based on the AI/ML model readiness state.

A WTRU may be configured and/or indicated to retain an AI/ML model in the AI engine (E.g. retain timer) within a certain amount of time to avoid AI/ML model deploy time. The retain timer may be determined and/or configured for each AI/ML functionality.

A WTRU may receive configuration information. The configuration information may indicate measurement reporting information for a plurality of (e.g., artificial intelligence/machine learning (AI/ML), non-AI/ML) processes. The WTRU may determine a processing unit allocation for each (e.g., AI/ML) process of the plurality of (e.g., AI/ML) processes, for example, based on one or more parameters. The one or more parameters may include a minimum processing time associated with each (e.g., AI/ML) process of the plurality of (e.g., AI/ML) processes, and/or a readiness status of each (e.g., AI/ML) process of the plurality of (e.g., AI/ML) processes. The WTRU may determine a processing unit availability based on the processing unit allocation for each (e.g., AI/ML) process of the plurality of (e.g., AI/ML) processes, the minimum processing time associated with each (e.g., AI/ML) process of the plurality of (e.g., AI/ML) processes, a maximum number of processing units at the WTRU, and/or capability of the processing units at the WTRU. The WTRU may determine a priority order for each (e.g., AI/ML) process of the plurality of (e.g., AI/ML) processes based on the processing unit availability. The WTRU may determine to process at least a subset of the plurality of (e.g., AI/ML) processes based on the priority order, the processing unit availability, and/or the processing unit allocation for each (e.g., AI/ML) process of the plurality of (e.g., AI/ML) processes. The at least a subset of the plurality of (e.g., AI/ML) processes may include one or more (e.g., all) of the (e.g., AI/ML) processes of the plurality of (e.g., AI/ML) processes. The at least subset of the plurality of (e.g., AI/ML, non-AI/ML) processes may be and/or include the plurality of (e.g., AI/ML, non-AI/ML) processes. The WTRU may send a report associated with each (e.g., AI/ML) process of the at least subset of the plurality of (e.g., AI/ML) processes.

The one or more parameters may include one or more of: per-functionality AI/ML processing unit (APU) occupation, an indication of AI/ML model complexity, an indication of WTRU capability, a number of simultaneous AI/ML functionalities for which inference is performed, and/or a priority associated with an AI/ML model.

The WTRU may send an indication of processing unit capability at the WTRU. The processing unit capability may include AI/ML processing unit (APU) capability and/or channel state information (CSI) processing unit (CPU) capability of the WTRU. The WTRU may receive the configuration information in response to the indication of the processing unit capability (e.g., APU capability or the CPU capability). The APU capability may include one or more of: an APU pool type, a maximum number of APU; an indication of one or more functionality specific parameters for per-functionality APU occupation calculation, an indication of one or more parameters for minimum time for AI/ML processing calculations; and/or an indication of CPU pool sharing for AI/ML.

The WTRU may determine an AI/ML processing unit (APU) allocation for one or more AI/ML functionalities, to minimize dropped reports or inference tasks, for example, to determine the processing unit allocation.

Each AI/ML process of the plurality of AI/ML processes may be associated with an AI/ML function. The AI/ML function may include one or more of: channel state information (CSI) reporting; beam management (BM) reporting; WTRU positioning measurements; sensing; AI-based receiver; and/or WTRU position prediction.

The WTRU may determine that the plurality of (e.g., AI/ML) processes are triggered. The processing unit availability may include AI/ML processing unit (APU) availability and/or channel state information (CSI) processing unit (CPU) availability.

The plurality of (e.g., AI/ML) processes may include a first (e.g., AI/ML) process and/or a second (e.g., AI/ML) process. The WTRU may switch from the first (e.g., AI/ML) process to the second (e.g., AI/ML) process, for example, based on the processing unit allocation, the processing unit availability, and/or the priority order.

A WTRU may receive configuration information. The configuration information may indicate measurement reporting information for a plurality of (e.g., artificial intelligence/machine learning (AI/ML)) processes. The WTRU may determine a processing unit allocation for each (e.g., AI/ML) process of the plurality of (e.g., AI/ML) processes, for example, based on one or more parameters. The one or more parameters may include a minimum processing time associated with each (e.g., AI/ML) process of the plurality of (e.g., AI/ML) processes, and/or a readiness status of each (e.g., AI/ML) process of the plurality of (e.g., AI/ML) processes. The WTRU may determine to process at least a subset of the plurality of (e.g., AI/ML) processes based on the processing unit allocation for each (e.g., AI/ML) process of the plurality of (e.g., AI/ML) processes. The WTRU may send a report associated with each (e.g., AI/ML) process of the at least subset of the plurality of (e.g., AI/ML) processes.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

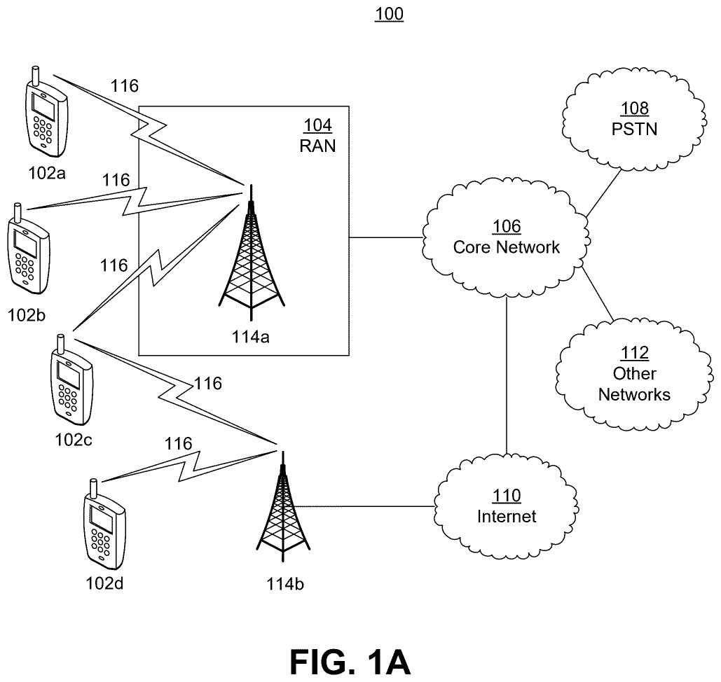

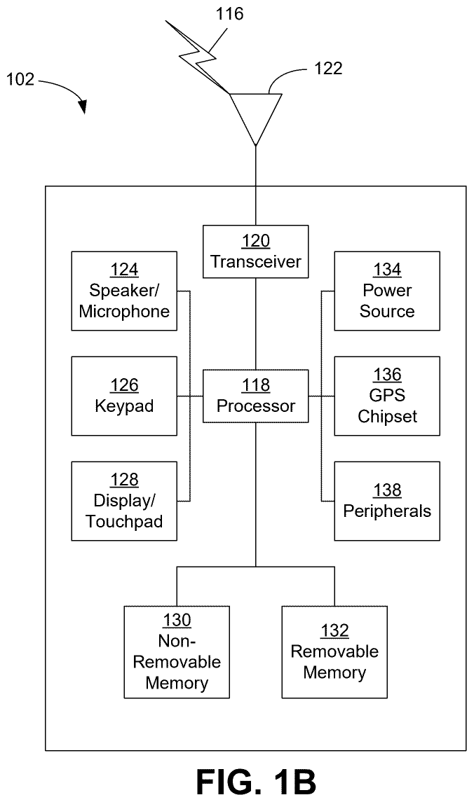

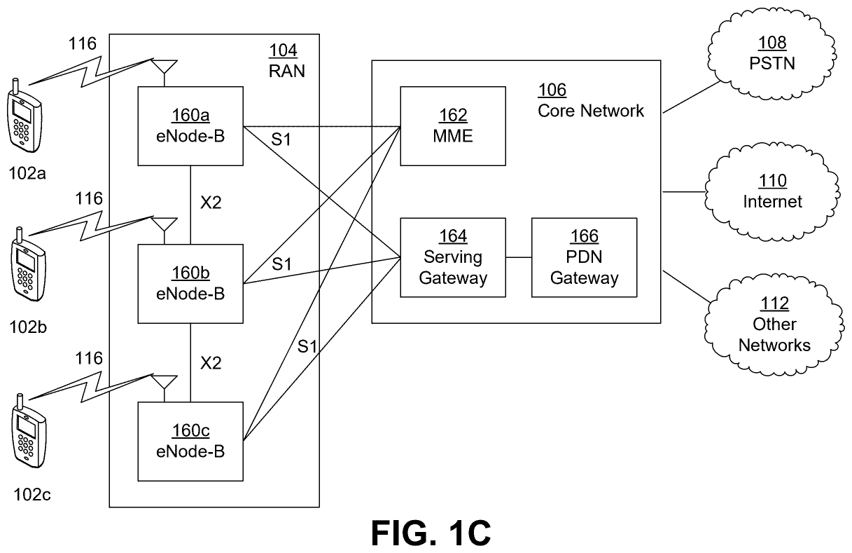

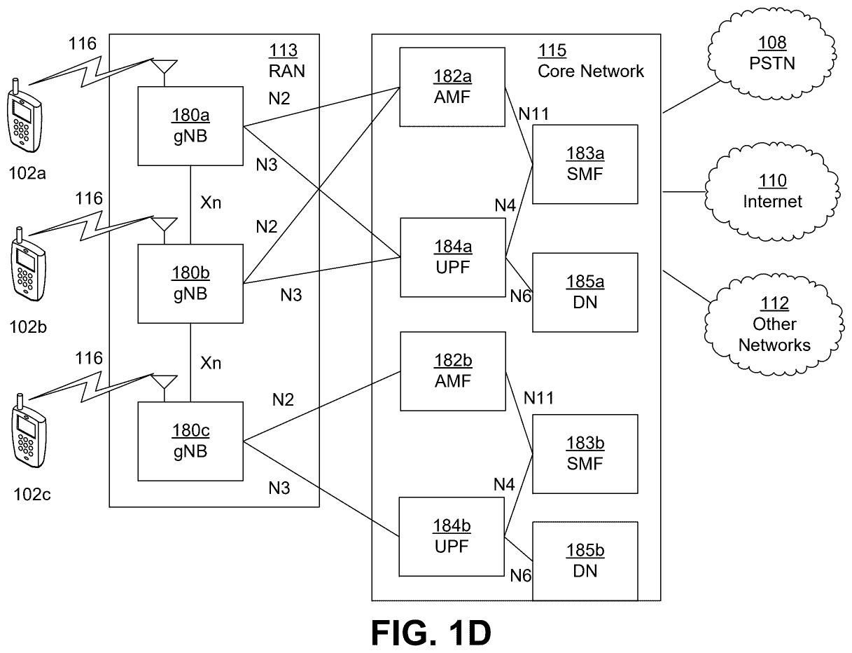

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may determine artificial intelligence/machine learning (AI/ML) processing unit (APU) availability and/or a priority order for (e.g., simultaneously) triggered AI/ML and/or non-AI/ML functionality(ies), for example, based on the determined APU availability, channel state information (CSI) processing unit (CPU) availability, and/or per-functionality/inter-functionality priority rule(s). The WTRU may determine one or more processing methods to process one or more of the (e.g., simultaneously) triggered AI/ML and/or non-AI/ML functionalities, for example, based on the priority order, APU availability, CPU availability, and/or determined APU allocation(s).

The priority order of AI/ML functionality(ies) and/or non-AI/ML functionality(ies) may be determined based on the number of APUs and/or CPUs, performance of the functionality(ies), and/or WTRU sided condition(s) (e.g., power mode, channel condition, etc.).

The required number of APUs may be determined based on timeline indicated by the network, number of AI/ML models associated with the functionality, and/or complexity (e.g., model size, flops) for the functionality and/or model.

AI/ML model readiness state (e.g., deployed in AI engine, AI engine has space and not deployed, AI engine has no space and not deployed) may be described herein and/or used to determine the required minimum processing time. The required minimum processing time may be determined based on the AI/ML model readiness state.

A WTRU may be configured and/or indicated to retain an AI/ML model in the AI engine (E.g. retain timer) within a certain amount of time to avoid AI/ML model deploy time. The retain timer may be determined and/or configured for each AI/ML functionality.

In LTE, for example, the timing for aperiodic channel state information (CSI) reporting may be fixed. The CSI reporting (e.g., in LTE) may be designed to fit within that timeline in terms of minimum required processing time. CSI process may be described herein (e.g., with respect to LTE), where the maximum number of CSI processes supported by a WTRU may be defined by the WTRU capability. Based on flexible timing indication for aperiodic CSI reporting (e.g., in NR), for example, another (e.g., new) mechanism may be included for the minimum processing time for CSI reports. Embodiments described herein may include CSI Processing Unit (CPU) (e.g., in NR), where the number of CPUs may be equal to the number of (e.g., simultaneous) CSI calculations supported by WTRU, which may be defined by the WTRU capability. CSI Processing Unit (CPU) may include a timeline for the start and/or the end of a CPU (e.g., for aperiodic, periodic, and/or semi-persistent CSI report(s)). The number of CPUs occupied may be defined for (e.g., both) non-beam related and/or beam-related reports. For example, there may be Ks occupied CPUs when Ks CSI-RS resources in the CSI-RS resource set for channel measurement for non-beam related reports, and/or 1 occupied CPU for beam related reports (e.g., which may have lower computational complexity). Embodiments described herein may include WTRU behavior and/or priority rules for the case when the number of unoccupied CPUs is smaller than the required number of CPUs for CSI reporting.

The AI/ML based functionality for AI/ML based CSI enhancements, AI/ML based beam management, and/or AI/ML based positioning, for example, may include one or more challenges of managing AI/ML processing resources and/or the CPU management for non-AI/ML based functionality.

For example, sharing the AI/ML resources among different AI/ML functionalities may require one or more priority rules. In examples, when an AI/ML functionality includes (e.g., both) AI/ML and/or non-AI/ML processing resources (e.g., non-AI/ML resources for pre-processing and/or post-processing the data, and/or AI/ML resources for model inference(s)), there may be no mechanism to define and/or manage the resource occupancy for AI/ML and/or non-AI/ML process(es). Examples may include minimum processing time, which for AI/ML functionality may be based on factor(s) including readiness, model complexity, and/or the like. Determination of minimum processing time may be (e.g., more) challenging for one or more AI/ML functionalities, for example, because minimum processing time may be a function of one or more factors (e.g., in comparison to non-AI/ML functionality). The one or more factors may include: model readiness time, a number of APUs allocated to the AI/ML functionality, a WTRU power saving mode, a WTRU battery status, and/or the like. This may make the problem of optimization and/or prioritization of APUs (e.g., more) complex. Unlike non-AI/ML framework, for example, AI/ML-based functionality may not include a one-to-one mapping between reports and number of occupied CPUs.

Non-AI/ML CPU management framework may not be flexible (e.g., enough) to address the challenges described herein. When a WTRU may be equipped with a limited number of AI/ML processing units, for example, one or more of the following may be addressed herein. How to account for the fact that one AI/ML-based functionality includes more than one processing unit may be addressed herein. The processing timeline for AI/ML-based functionality may be addressed herein. How to share AI/ML processing resources among different AI/ML based functionalities may be addressed herein. How to share non-AI/ML processing resources among different AI/ML and/or non-AI/ML functionalities may be addressed herein. How to share the AI/ML and/or non-AI/ML resources for one or more (e.g., multiple) carriers may be addressed herein. How to share the AI/ML and/or non-AI/ML resources for cooperative WTRUs may be addressed herein.

A WTRU may determine APU availability and/or the priority order for (e.g., simultaneously) triggered AI/ML and/or non-AI/ML functionality(ies) based on, for example, the determined APU availability, CPU availability, and/or per-functionality and/or inter-functionality priority rule(s). The WTRU may determine one or more processing methods to process one or more of the (e.g., simultaneously) triggered AI/ML and/or non-AI/ML functionalities, for example, based on the determined priority order, APU availability, CPU availability, and/or determined APU allocation(s).

A WTRU may receive configuration information. The configuration information may indicate measurement reporting information for a plurality of (e.g., artificial intelligence/machine learning (AI/ML)) processes. The WTRU may determine a processing unit allocation for each (e.g., AI/ML) process of the plurality of (e.g., AI/ML) processes, for example, based on one or more parameters. The one or more parameters may include a minimum processing time associated with each (e.g., AI/ML) process of the plurality of (e.g., AI/ML) processes, and/or a readiness status of each (e.g., AI/ML) process of the plurality of (e.g., AI/ML) processes. The WTRU may determine a processing unit availability based on the processing unit allocation for each (e.g., AI/ML) process of the plurality of (e.g., AI/ML) processes, the minimum processing time associated with each (e.g., AI/ML) process of the plurality of (e.g., AI/ML) processes, a maximum number of processing units at the WTRU, and/or capability of the processing units at the WTRU. The WTRU may determine a priority order for each (e.g., AI/ML) process of the plurality of (e.g., AI/ML) processes based on the processing unit availability. The WTRU may determine to process at least a subset of the plurality of (e.g., AI/ML) processes based on the priority order, the processing unit availability, and/or the processing unit allocation for each (e.g., AI/ML) process of the plurality of (e.g., AI/ML) processes. The at least a subset of the plurality of (e.g., AI/ML) processes may include one or more (e.g., all) of the (e.g., AI/ML) processes of the plurality of (e.g., AI/ML) processes. The at least subset of the plurality of (e.g., AI/ML, non-AI/ML) processes may be the plurality of (e.g., AI/ML, non-AI/ML) processes. The WTRU may send a report associated with each (e.g., AI/ML) process of the at least subset of the plurality of (e.g., AI/ML) processes.

A WTRU may receive configuration information. The configuration information may indicate measurement reporting information for a plurality of (e.g., artificial intelligence/machine learning (AI/ML)) processes. The WTRU may determine a processing unit allocation for each (e.g., AI/ML) process of the plurality of (e.g., AI/ML) processes, for example, based on one or more parameters. The one or more parameters may include a minimum processing time associated with each (e.g., AI/ML) process of the plurality of (e.g., AI/ML) processes, and/or a readiness status of each (e.g., AI/ML) process of the plurality of (e.g., AI/ML) processes. The WTRU may determine to process at least a subset of the plurality of (e.g., AI/ML) processes based on the processing unit allocation for each (e.g., AI/ML) process of the plurality of (e.g., AI/ML) processes. The WTRU may send a report associated with each (e.g., AI/ML) process of the at least subset of the plurality of (e.g., AI/ML) processes.

A WTRU may send an indication of processing unit capability at the WTRU. The processing unit capability may include AI/ML processing unit (APU) capability and/or channel state information (CSI) processing unit (CPU) capability of the WTRU. The WTRU may receive the configuration information in response to the indication of the processing unit capability (e.g., APU capability or the CPU capability). The APU capability may include one or more of: an APU pool type, a maximum number of APU; an indication of one or more functionality specific parameters for per-functionality APU occupation calculation, an indication of one or more parameters for minimum time for AI/ML processing calculations; and/or an indication of CPU pool sharing for AI/ML. A WTRU may send a report. For example, the WTRU may report AI/ML processing unit (APU) capability and/or CPU capability. APU processing capability may include one or more of the following. APU processing capability may include a APU pool type. APU pool type may be AI/ML functionality specific, AI/ML LCM function specific, and/or joint APU pool (e.g., APU resources pooled among one or more (all) supported AI/ML functionalities, including AI/ML LCM functions). APU processing capability may include a maximum of number of APU. For example, a total (joint) pool size, and/or per AI/ML functionality, etc. (e.g., per CC, per band/band combination). APU processing capability may include one or more functionality specific parameter(s) for per-functionality APU occupation (O_APU) calculation. For example, APU processing capability may include a minimum number of APUs required for a functionality. For example, O_APU=N4 for AI/ML-based prediction with N4 predicted CSI instances. APU processing capability may include one or more parameters for minimum time for AI/ML processing calculations (e.g., T_AP). For example, APU processing capability may include one or more scaling factors for the processing time as a function of the number of APUs allocated to an AI/ML functionality. For example, APU processing capability may include computing performance capability (e.g., FLOPS) of the WTRU. APU processing capability may include CPU pool sharing for AI/ML, which may indicate whether the WTRU has the capability to share a CPU pool for AI/ML and/or non-AI/ML functionality (e.g., CPU pool shared among AI/ML-based CSI and non-AI/ML based CSI).

The WTRU may receive configuration information for a set of measurement reports for one or more AI/ML functionalities (e.g., CSI report, BM report, WTRU positioning measurements, sensing, AI-based receiver, WTRU position prediction, etc.). For example, a WTRU may receive configuration information. The configuration information may indicate measurement reporting information for a plurality of processes. The configuration information may indicate measurement reporting information for a plurality of artificial intelligence/machine learning (AI/ML) processes and/or for a plurality of non-AI/ML processes. Each AI/ML process of the plurality of (e.g., AI/ML) processes may be associated with an AI/ML function. The AI/ML function may include one or more of: channel state information (CSI) reporting; beam management (BM) reporting; WTRU positioning measurements; sensing; AI-based receiver; and/or WTRU position prediction.

The WTRU may determine a processing unit allocation for each process of the plurality of processes. For example, the WTRU may determine a processing unit allocation for each AI/ML process of the plurality of AI/ML processes and/or for each non-AI/ML process of the plurality of non-AI/ML processes, for example, based on one or more parameters. The one or more parameters may include a minimum processing time associated with each AI/ML process of the plurality of AI/ML processes, a minimum processing time associated with each non-AI/ML process of the plurality of non-AI/ML processes, and/or a readiness status of each AI/ML process of the plurality of AI/ML processes. The one or more parameters may include one or more of: per-functionality AI/ML processing unit (APU) occupation, an indication of AI/ML model complexity, an indication of WTRU capability, a number of simultaneous AI/ML functionalities for which inference is performed, and/or a priority associated with an AI/ML model. The WTRU may determine an AI/ML processing unit (APU) allocation for one or more AI/ML functionalities, to minimize dropped reports or inference tasks, for example, to determine the processing unit allocation. The WTRU may determine that the plurality of (e.g., AI/ML) processes are triggered. When the WTRU is triggered to perform inference for one or more AI/ML functionalities, for example, the WTRU may determine an APU allocation for each AI/ML functionality. The WTRU may determine the APU allocation for each AI/ML functionality based on one or more of: per-functionality APU occupation, an associated time for AI/ML processing (T_AP) for each AI/ML functionality, AI/ML model readiness status, AI/ML model complexity and/or WTRU capability, a number of (e.g., simultaneous) AI/ML functionalities for which inference is performed, priority, and/or the like. For example, the WTRU may determine an APU allocation for one or more functionalities to minimize the dropped reports and/or inference tasks. The time for AI/ML processing may be a function of AI/ML model readiness statues. The AI/ML model readiness status may include one or more of the following: available; configured (e.g., has received RRC configuration for inference); active (e.g., loaded in memory, with inference configuration available, ready to be loaded to the AI engine/graphical processing unit (GPU)); and/or on GPU (e.g., ready to perform inference).

The WTRU may determine an APU availability. For example, the WTRU may determine an APU availability based on the APU allocation(s) of the one or more (e.g., simultaneously) triggered AI/ML functionalities, the AI/ML processing time(s) of the one or more (e.g., simultaneously) triggered AI/ML functionalities, a maximum number of APUs and/or APU capabilities. For example, the WTRU may determine a processing unit availability based on the processing unit allocation for each (e.g., AI/ML, non-AI/ML) process of the plurality of (e.g., AI/ML, non-AI/ML) processes, the minimum processing time associated with each (e.g., AI/ML, non-AI/ML) process of the plurality of AI/ML processes, a maximum number of processing units at the WTRU, and/or capability of the processing units at the WTRU. The processing unit availability may include AI/ML processing unit (APU) availability and/or channel state information (CSI) processing unit (CPU) availability.

The WTRU may determine a priority order for each (e.g., simultaneously) triggered AI/ML and/or non-AI/ML functionality based on one or more of: APU availability, CPU availability, and/or per-functionality/inter-functionality priority rule(s). For example, the WTRU may determine a priority order for each (e.g., AI/ML, non-AI/ML) process of the plurality of (e.g., AI/ML, non-AI/ML) processes based on the processing unit availability.

The WTRU may determine one or more processing methods to process one or more of the (e.g., simultaneously) triggered AI/ML and/or non-AI/ML functionalities, for example, based on one or more of the priority order, APU availability, CPU availability, and/or determined APU allocation(s). For example, when AI/ML functionality#1 requires N1_APU and N1_CPU, the WTRU may use a CPU pool when the APU pool is not available (e.g., the WTRU may use k*N1_CPU and/or may update the minimum processing time), if the updated minimum processing time meets the available timeline. For example, when AI/ML functionality#1 requires N1_APU and N1_CPU, the WTRU may fall back to non-AI/ML processing when the APU is not available and/or the updated minimum processing time for AI/ML processing on CPU does not meet the available timeline. For example, when an AI/ML functionality is allocated (e.g., enough) APUs and/or may be prioritized, the WTRU may use AI/ML processing for that functionality. For example, when the allocated number of APUs exceeds the number of available APUs, the WTRU may drop one or more lower priority processes. For example, the WTRU may determine to process at least a subset of the plurality of processes. For example, the WTRU may determine to process at least a subset of the plurality of AI/ML processes and/or at least a subset of the plurality of non-AI/ML processes based on the priority order, the processing unit availability, and/or the processing unit allocation for each AI/ML process of the plurality of AI/ML processes and/or for each non-AI/ML process of the plurality of non-AI/ML processes. The at least a subset of the plurality of AI/ML processes may include one or more (e.g., all) of the AI/ML processes of the plurality of AI/ML processes. The at least subset of the plurality of (e.g., AI/ML, non-AI/ML) processes may be and/or include the plurality of (e.g., AI/ML, non-AI/ML) processes. The WTRU may determine a processing method, for example, based on the priority order, the processing unit availability, and/or the processing unit allocation for each (e.g., triggered) AI/ML process of the plurality of AI/ML processes and/or the processing unit allocation for each (e.g., triggered) non-AI/ML process of the plurality of non-AI/ML processes to determine to process at least a subset of the plurality of processes.

The WTRU may process a functionality based on the determined priority and/or determined processing method. The WTRU may report the measurement(s) for the selected functionality.

The WTRU may send a report associated with each process of the plurality of processes. For example, the WTRU may send a report associated with each AI/ML process of the at least subset of the plurality of AI/ML processes and/or associated with each non-AI/ML process of the at least subset of non-AI/ML processes. The WTRU may report one or more identifiers for dropped processes and/or AI/ML functionalities for which non-AI/ML processing has been determined.

Embodiments described herein may include a consistent and predictable WTRU behavior when handling one or more (e.g., multiple) AI/ML functionalities. Additionally or alternatively, the embodiments described herein for sharing AI/ML processing resources among different AI/ML based functionalities, and/or for sharing non-AI/ML processing resources among different AI/ML and/or non-AI/ML functionalities may result in minimizing the dropped reports and/or inference tasks.

Embodiments described herein may include AI/ML processing units (APU) pool sharing for AI/ML functionality(ies). A WTRU may be configured with and/or may have a number of AI/ML processing units. An APU may be used for wireless transmission (e.g., physical (PHY), medium access control (MAC), and/or radio resource control (RRC)) functionality processing.

A WTRU may have one or more APUs assigned (and/or dedicated) to a specific AI/ML functionality. A WTRU may have one or more APUs assigned (and/or dedicated) to a set and/or pool of AI/ML functionalities. A WTRU may have one or more APUs assigned (and/or dedicated) to an AI/ML lifecycle management (LCM) function (e.g., associated with an AI/ML functionality). A WTRU may have one or more APUs assigned (and/or dedicated) to a set and/or pool of AI/ML LCM functions. A WTRU may have one or more APUs assigned (and/or dedicated) to a set and/or pool of AI/ML functionalities and/or a set and/or a pool of AI/ML LCM functions.

A WTRU may have a maximum number of APUs for (e.g., wireless) transmission functionality processing. The maximum number of APUs for (e.g., wireless) transmission functionality may be defined per processing instance. For example, at a given moment, a WTRU may process a number of (e.g., wireless) functions such that the number of APUs required to perform the processing is less than the maximum number of APUs.

The maximum number of APUs for (e.g., wireless) transmission functionality processing may be fixed and/or variable. For example, the WTRU may have a pool of APUs to be shared between (e.g., wireless) transmission functionality processing and other application(s). In examples, the maximum number of APUs available in an instance may be dynamically determined by the WTRU.

The maximum number of APUs may be determined per at least one of the following. The maximum number of APUs may be determined per AI/ML functionality. The maximum number of APUs may be determined per set and/or pool of AI/ML functionalities. The maximum number of APUs may be determined per component carrier. The maximum number of APUs may be determined per bandwidth and/or bandwidth part and/or band and/or band combination. The maximum number of APUs may be determined per transmission/reception point (TRP) and/or TRP set. The maximum number of APUs may be determined as an absolute maximum for one or more (e.g., any) of the combinations described herein.

A WTRU may determine and/or may be configured with a requirement for a specific and/or minimum number of APUs per AI/ML functionality. Additionally or alternatively, the WTRU may determine and/or may be configured with a requirement for a specific and/or a minimum number of APUs per AI/ML model within an AI/ML functionality, where one or more AI/ML models may be used within an AI/ML functionality. The determination may be based on at least one of the following. The determination may be based on an AI/ML functionality type. For example, CSI prediction may include a first number of APUs, and/or beam management prediction may include a second number of APUs. The determination may be based on one or more parameters of the AI/ML functionality. For example, the required number of APUs for CSI prediction may be based on the number of instances being predicted. For example, the number of required APUs may be a function of a first number of APUs multiplied by the number of prediction instances to be determined and/or inferred and/or reported. The determination may be based on one or more parameters associated with the measurement resource and/or reporting resource. For example, the required number of APUs may be based on a measurement reporting type (e.g., periodic, semi-persistent, aperiodic), and/or a measurement reference signal type (e.g., periodic, semi-persistent, aperiodic), and/or a measurement reporting resource (e.g., uplink control information (UCI), MAC control element (CE), RRC), and/or a reporting configuration (e.g., a number of antenna ports, a number of measurement resources, a codebook type, etc.). The determination may be based on a configuration received from the network. The determination may be based on an AI/ML model type and/or one or more AI/ML model parameters. The determination may be based on one or more AI/ML performance requirements. The determination may be based on an LCM configuration. For example, the WTRU may determine a first required number of APUs for inference and/or reporting of an AI/ML functionality, and/or a second required number of APUs for performance monitoring and/or other LCM requirement(s) for the same AI/ML functionality.

AI/ML functionality may be interchangeably used with AI/ML model, AI/ML model of an AI/ML functionality, a group of AI/ML models, AI/ML use case, and/or AI/ML sub-use case.

A WTRU may determine a number of allocated APUs (e.g., the APU allocation) for one or more AI/ML functionality(ies). The APU allocation for an AI/ML functionality may be determined based on at least one of the following.

The APU allocation for an AI/ML functionality may be determined based on a minimum and/or required (e.g., APU occupation) number of APUs for the functionality.

The APU allocation for an AI/ML functionality may be determined based on (e.g., simultaneous) AI/ML functionality operation. For example, the WTRU may determine an APU allocation for a first functionality based on the total number of (e.g., simultaneous, concurrent) AI/ML functionalities. In examples, the WTRU may determine an APU allocation for a first functionality based on the functionality type (e.g., CSI prediction, CSI compression, BM, positioning, mobility, one or more other AI/ML use cases, etc.) and/or the functionality type of one or more other (e.g., simultaneous, concurrent) AI/ML functionality.

The APU allocation for an AI/ML functionality may be determined based on AI/ML operation. For example, the APU allocation may be based on the AI/ML operation (e.g., whether it is for inference, pre-processing, post-processing, and/or LCM (validation, performance monitoring, model activation, model deactivation, model switching, model training, etc.). AI/ML operation may be interchangeably used with AI/ML process, AI/ML mode, and/or AI/ML procedure.

The APU allocation for an AI/ML functionality may be determined based on one or more parameters of the AI/ML functionality. For example, an APU allocation may be determined based on the number of predictions required for a report. In examples, the APU allocation may be based on the number of required inferences for one operation.

The APU allocation for an AI/ML functionality may be determined based on one or more parameters associated with the measurement resource(s) and/or reporting resource(s). For example, the APU allocation may be based on a measurement reporting type (e.g., periodic, semi-persistent, aperiodic), and/or a measurement reference signal type (e.g., periodic, semi-persistent, aperiodic), and/or a measurement reporting resource (e.g., uplink control information (UCI), MAC control element (CE), RRC), and/or a reporting configuration (e.g., a number of antenna ports, a codebook type, etc.).

The APU allocation for an AI/ML functionality may be determined based on an AI/ML functionality processing time associated with candidate and/or available APU allocation(s). For example, a WTRU may determine an APU allocation for an AI/ML functionality based on minimizing and/or maximizing the AI/ML functionality processing time for that AI/ML functionality. In examples, a WTRU may determine an APU allocation for one or more functionalities based on optimizing the (e.g., over-all) AI/ML functionality processing time. For example, the over-all AI/ML functionality processing time may be the sum of one or more (e.g., all) AI/ML functionality processing times for each AI/ML functionality. Optimizing the (e.g., over-all) AI/ML functionality processing time may include one or more of: maximizing and/or minimizing each AI/ML functionality processing time, maximizing and/or minimizing the average AI/ML functionality processing time, and/or maximizing and/or minimizing the total AI/ML functionality processing time.

The APU allocation for an AI/ML functionality may be determined based on WTRU capability and/or processing power. For example, the APU allocation for an AI/ML functionality may be determined based on a maximum and/or minimum number of floating-point operations per second (FLOPS). In examples, the number of FLOPs may be per allocated APU.

The APU allocation for an AI/ML functionality may be determined based on an AI/ML model type and/or one or more AI/ML model parameters. For example, the APU allocation may be based on the model size and/or model complexity and/or required number of FLOPs and/or FLOPS. In examples, an AI/ML model may perform N inferences (e.g., simultaneously); one or more (e.g., some) functionalities may require M (where M>N) inference procedures. The APU allocation may be determined as a function of N, M, and/or the time for each inference procedure.

The APU allocation for an AI/ML functionality may be determined based on AI/ML model readiness. For example, the APU allocation for one instance of an AI/ML functionality may be based on the readiness state of the required and/or associated AI/ML model. Each readiness state may have a configurable and/or fixed required APU allocation. AI/ML readiness states may include at least one of: AI/ML located in AI engine, AI/ML located in buffer and AI engine has space, AI/ML located in buffer and AI engine is full, and/or AI/ML located neither in AI engine and/or in buffer.

The APU allocation for an AI/ML functionality may be determined based on a priority of an AI/ML functionality. For example, the WTRU may determine an APU allocation for an AI/ML functionality based on the priority of the AI/ML functionality and/or based on the priority of another (e.g., simultaneous) AI/ML functionality.

The APU allocation for an AI/ML functionality may be determined based on maximizing the number of (e.g., simultaneously) supported and/or activated AI/ML functionality(ies). For example, an APU allocation for one or more AI/ML functionalities may be determined such as to minimize the number of functionalities that may (e.g., either) be dropped and/or be handled without AI/ML (e.g., using a fallback method). For example, if one or more first AI/ML functionalities are allocated a number of APUs greater than the minimum requirement (e.g., functionality specific APU occupation), and/or one or more second functionality(ies) can not support AI/ML operation, the WTRU may reduce the APU allocation(s) for at least one of the one or more first AI/ML functionalities until one or more (e.g., all) second functionalities support AI/ML operation and/or until one or more (e.g., all) first AI/ML functionalities are assigned the minimum required number of APUs. After which, one or more (e.g., any) remaining and/or unused APUs may be (re)assigned to at least one of the AI/ML functionalities.

An APU allocation of APU occupation for an AI/ML functionality may be a fixed value, for example, 1.

A WTRU's APU availability may include a number of unused, available, and/or unoccupied APUs (e.g., after APU allocation to one or more AI/ML functionalities). The APU availability may be determined based on the maximum number of APUs and/or based on the APU allocation(s) for the one or more AI/ML functionalities. The APU availability may consider CPUs, for example, if CPU pool sharing for AI/ML is included.

When one or more CPUs from a CPU pool can be shared for AI/ML operation, for example, the number of CPUs (e.g., each CPU may be equivalent to each APU, one or more CPUs may be equivalent to one APU) may be determined based on at least one of the following. For example, the WTRU and/or gNB may determine how many CPUs are equivalent to one APU, and/or how many CPUs are included for AI/ML operation (e.g., how many CPUs are included to replace one or more APUs).

The number of CPUs may be determined based on WTRU capability. For example, a WTRU may report the ratio between CPU and APU for AI/ML operation. To replace 1 APU, one or more CPUs may be required. Additionally or alternatively, 1 CPU may replace one or more APUs.

The number of CPUs may be determined based on a (e.g., fixed) ratio. For example, N1-to-N2 ratio may be used irrespective of AI/ML functionality. N1 CPU may replace N2 APU.

The number of CPUs may be determined based on a ratio determined based on AI/ML functionality. For example, a first ratio (e.g., {N1=1, N2=1}) may be pre-determined and/or used for a first AIML functionality (e.g., CSI prediction) and/or a second ratio (e.g., {N1=2, N2=1}) may be pre-determined and/or used for a second AIML functionality (e.g., CSI compression).

A WTRU may determine an AI/ML functionality processing time (e.g., APU occupation time) as a function of at least one or more of the following.

A WTRU may determine an AI/ML functionality processing time (e.g., APU occupation time) as a function of a minimum and/or required (e.g., APU occupation), and/or determined number of APUs allocated to the functionality (e.g., APU allocation).

A WTRU may determine an AI/ML functionality processing time (e.g., APU occupation time) as a function of a fixed and/or configurable time per functionality and/or per APU time processing time requirement(s).

A WTRU may determine an AI/ML functionality processing time (e.g., APU occupation time) as a function of an AI/ML functionality type. For example, each of CSI prediction, CSI compression, BM, positioning, mobility, and/or one or more (e.g., any) other use cases may have a functionality specific processing time (and/or functionality specific base processing time). The AI/ML functionality processing time may (e.g., also) be based on a number of (e.g., concurrently, simultaneously) handled AI/ML functionality. The AI/ML functionality processing time for a functionality may be based on the function and/or the function type(s) of other (e.g., simultaneous) function(s).

A WTRU may determine an AI/ML functionality processing time (e.g., APU occupation time) as a function of an AI/ML operation. For example, the AI/ML functionality processing time may be based on the AI/ML operation. For example, the AI/ML functionality processing time may be based on whether it is for inference, pre-processing, post-processing, and/or LCM (e.g., validation, performance monitoring, model activation, model deactivation, model switching, model training, and/or the like).

A WTRU may determine an AI/ML functionality processing time (e.g., APU occupation time) as a function of one or more parameters of the AI/ML functionality. For example, an AI/ML functionality processing time may be determined based on the number of predictions required for one report. In examples, the AI/ML functionality processing time may be based on the number of required inferences for one operation.

A WTRU may determine an AI/ML functionality processing time (e.g., APU occupation time) as a function of one or more parameters associated with the measurement resource(s) and/or reporting resource(s). For example, the AI/ML functionality processing time may be based on a measurement reporting type (e.g., periodic, semi-persistent, aperiodic), and/or a measurement reference signal type (e.g., periodic, semi-persistent, aperiodic), and/or a measurement reporting resource (e.g., uplink control information (UCI), MAC control element (CE), RRC), and/or a reporting configuration (e.g., a number of antenna ports, a codebook type, etc.).

A WTRU may determine an AI/ML functionality processing time (e.g., APU occupation time) as a function of a scaling factor. For example, a WTRU may determine an AI/ML functionality processing time (e.g., APU occupation time) as a function of a scaling factor for the processing time as a function of the number of APUs allocated to an AI/ML functionality (and/or as a function to the required number of APUs for the functionality).

A WTRU may determine an AI/ML functionality processing time (e.g., APU occupation time) as a function of WTRU capability. For example, a WTRU may determine an AI/ML functionality processing time (e.g., APU occupation time) as a function of a maximum and/or minimum number of FLOPs. In examples, the number of FLOPS may be per allocated APU.

A WTRU may determine an AI/ML functionality processing time (e.g., APU occupation time) as a function of an AI/ML model type and/or one or more AI/ML model parameters. For example, the AI/ML processing time may be based on the model size and/or model complexity and/or required number of FLOPs and/or FLOPS. In examples, an AI/ML model may perform N inferences (e.g., simultaneously), and/or one or more (e.g., some) functionalities may require M (e.g., where M>N) inference procedures. The AI/ML functionality time may be determined as a function of N, M, and/or time for each inference procedure (e.g., total time may equal the time for each inference procedure*(M/N), and/or total time may equal the time for each inference procedure*ceil(M/N)).

A WTRU may determine an AI/ML functionality processing time (e.g., APU occupation time) as a function of AI/ML model readiness. For example, the AI/ML processing time for one instance of an AI/ML functionality may be based on the readiness state of the required and/or associated AI/ML model. Each readiness state may have a configurable and/or fixed required APU allocation. AI/ML readiness states may include at least one of: AI/ML located in AI engine, AI/ML located in buffer and AI engine has space, AI/ML located in buffer and AI engine is full, and/or AI/ML located neither in AI engine and/or in buffer.

A WTRU may determine an AI/ML functionality processing time (e.g., APU occupation time) as a function of WTRU capability and/or processing power.

A WTRU may determine an AI/ML functionality processing time (e.g., APU occupation time) as a function of subcarrier spacing.

A WTRU may determine an AI/ML functionality processing time (e.g., APU occupation time) as a function of a timing advance value.

The WTRU may determine the functionality processing time as a sum of time values determined from one or more components as described herein. In examples, each time value for each component may be determined independently. In examples, a time value for one component may be based on the time value of another component. For example, one or more (e.g., some) time components may be processed simultaneously and/or in parallel (e.g., using the same APUs). For example, the WTRU may move an AI/ML from the buffer to the AI engine while performing one or more measurements on reference signals. In examples, the time value for the one or more (e.g., two) components may be the greater value of the two.

AI/ML functionality processing time (T_{MIN}) may be a minimum processing time required for processing an AI/ML functionality. A WTRU may perform AI/ML functionality when the determined AIML functionality processing time is equal to and/or smaller than the allowed AIML processing time (T_{PROC}). When T_{MIN}>T_{PROC}, for example, a WTRU may drop one or more actions related to the AIML functionality (e.g., report dummy information, drop reporting, skip updating measurement, skip decoding, etc.). The allowed AIML processing time (T_{PROC}) may be based on a start time and/or an end time.

The start time may include one or more of the following. The start time may include a first symbol (and/or last symbol) of control channel which may trigger activate, enable, and/or schedule to trigger the AI/ML functionality. The start time may include a first symbol (and/or last symbol) of one or more measurement resources associated with the AI/ML functionality. The start time may include a first (and/or last) measurement resource associated with the AI/ML functionality.

The end time may include one or more of the following. The end time may include a first symbol of uplink resource used for delivering the output of the AI/ML functionality (e.g., CSI reporting, beam reporting, positioning measurement reporting, etc.). The end time may include a time location which may trigger a WTRU action based on the output of the AI/ML functionality (e.g., SRS transmission, SR transmission, BFR indication, etc.).

In examples, the AI/ML functionality processing (e.g., T_{MIN}) may be scalable based on the number of APUs allocated. For example, T_{MIN} may be determined as a function a nominal processing time (T_{NOM}), and/or number of APUs allocated (e.g., N_{APU}), T_{MIN}=func(T_{NOM}, α, N_{APU}), where α may represent a scalar which may be applied to nominal processing time and/or number of APUs.

A WTRU may be configured for and/or may use a CPU pool sharing for AI/ML. When CPU pool sharing is available, for example, the WTRU may share a CPU pool for AI/ML and/or non-AIML functionality. For example, a CPU pool may be shared between and/or among AI/ML based CSI determination and/or reporting, and/or non-AIML based CSI determination and/or reporting.

For an AI/ML functionality, a WTRU may allocate one or more of the following. For an AI/ML functionality, the WTRU may allocate a number of APUs, where the number may be greater than and/or equal to the minimum number of required APUs for the AI/ML functionality. For an AI/ML functionality, the WTRU may allocate a number of CPUs, where the number of CPUs may be based on the AI/ML functionality and/or whether CPU pool sharing is available. For example, a WTRU may allocate a number of CPUs based on a determination of whether CPU pool sharing is possible. CPU pool sharing for AI/ML may be available from a HW architecture standpoint and/or WTRU capability. The CPU pool sharing for AI/ML may not (e.g., always) be possible, for example, when the number of CPUs required for an AI/ML process (e.g., to replace one APU) is less than the number of unoccupied CPUs.

A WTRU may send an indication. For example, the WTRU may send an indication to a network. The indication may indicate the WTRU's APU capability(ies) for one or more AI/ML functionalities and/or associated LCM. The WTRU may indicate one or more of the following. The WTRU may indicate a maximum and/or minimum number of APUs. AI/ML functionality processing time may be determined based on the number of APUs. For example, when a maximum number of APUs is used, a shortest minimum processing time (e.g., T_{MIN,short}) may be required; and/or when a minimum number of APUs is used, a longest minimum processing may be required (e.g., T_{MIN,long}), where T_{MIN,short}<T_{MIN,long}. The WTRU may indicate a maximum number of (e.g., simultaneously) processable AI/ML functionalities. The WTRU may indicate functionality specific APU occupation. The WTRU may indicate functionality specific processing time calculation and/or one or more parameters (e.g., scaling factor based on allocated number of APUs). The WTRU may indicate APU allocation. The WTRU may indicate APU availability. The WTRU may indicate CPU pool sharing and/or one or more parameters thereof.

In examples, a WTRU may determine AI/ML functionality processing time (e.g., T_{MIN}, CSI computation time) based on time taken to make/prepare the AI/ML model ready for inference (value of T_{R}−a ‘readiness time’) and/or the (e.g., actual) inference time (T_{INF}), e.g., T_{MIN}=T_{R}+T_{INF}+T_{O}. T_{O} may be from other processing time required for the AI/ML functionality not related to AI/ML operation (e.g., pre-processing, post-processing). For example, the readiness time may be based on the location of AI/ML model. For example, the readiness time (e.g., T_{R}) may be zero if the AI/ML model is loaded in the AI engine. The term AI engine may refer to one or more (e.g., any) hardware devices optimized for the AI/ML model inference. Based on the implementation/platform, for example, the AI engine may refer to GPU, Tensor Processing Unit (TPU), Neural Processing Unit (NPU), Custom Application-Specific Integrated Circuits (ASICs), and/or an on-chip/local memory thereof, etc. For example, the readiness time may be non-zero value for R if the AI/ML model is not loaded in the AI engine. For example, the readiness time may be a non-zero value for T_{R} if the AI/ML model is in a memory (e.g., RAM, storage drive, solid state device (SSD), flash memory etc.) and/or the AI/ML is to be loaded to the AI engine. CSI processing time, CSI computation time, AI/ML processing time, AI/ML functionality processing time, and/or AIML model processing time may be interchangeably used.

In examples, the non-zero value for T_{R} may accommodate the time taken to move the AIML model from outside the non-AI engine to the AI engine (e.g., a model load time). The value of T_{R} may be based on WTRU capability per AIML model readiness states.

The value of T_{R} may be predefined (e.g., in the standards). The value of T_{R} may be function of AI/ML model size. The value of T_{R} may be a function of availability of data (e.g., input data) for model inference in the AI engine (e.g., data load time). Such data may (e.g., need to) be processed (e.g., pre-processed) in CPU and/or loaded on to the AI engine. In examples, the value of zero and/or non-zero may be described as examples. For example, a first value may be applied (e.g., instead of zero) and/or a second value may be applied (e.g., instead of non-zero). In examples, the embodiments described in terms of AI/ML model may be applicable for the case of functionality-based LCM; readiness, load time, switching, activation/deactivation, reconfiguration, etc., may be associated with functionality.

The value of T_{R} may be a function of AI/ML model readiness state and/or WTRU capability. The AI/ML model readiness state may include one or more of the following. The AI/ML model readiness state may include Readiness state#0: AI/ML located in AI engine (e.g., T_{R}=0 time-units). The AI/ML model readiness state may include Readiness state#1: AI/ML located in buffer and AI engine has space (e.g., T_{R}=5 time-units). The AI/ML model readiness state may include Readiness state#2: AI/ML located in buffer and AI engine is full (e.g., T_{R}=10 time-units). The AI/ML model readiness state may include Readiness state#3: AI/ML located neither in AI engine and/or in buffer (e.g., T_{R}=time required for model transfer, and/or not applicable).

In examples, the model readiness time (T_{R}) may be impacted by one or more of following.

The model readiness time (T_{R}) may be impacted by a model switch procedure. For example, readiness time considering model switch may be impacted by one or more of the following: time for determining model switch (e.g., the need for model switch), time to identify the target model, load time of the target model, etc.

The model readiness time (T_{R}) may be impacted by a model activation procedure. For example, the readiness time considering model activation may be impacted by one or more of the following: time for processing model activation command (e.g., from MAC CE), load time for activated model, data load time, etc.

The model readiness time (T_{R}) may be impacted by a reconfiguration procedure. For example, the readiness time considering reconfiguration procedure may be impacted by one or more of the following: time for processing the RRC message, load time for AI/ML model, data load time, etc.

In examples, the WTRU may be configured with and/or determine computation (e.g., processing) time based on the AI/ML operation (e.g., LCM function, inference). For example, different computation time(s) may be configured for different LCM function(s). The WTRU may be configured with a first computation time value for inference. In examples, (e.g., both) CPU and/or APU usage may be included for inference. In examples, the WTRU may be configured with a second computation time value for data collection. CPU usage (e.g., only) may be included for data collection. The WTRU may be configured with a third computation time value for performance monitoring. CPU usage may (e.g., only) be determined for input distribution-based performance monitoring. In examples, (e.g., both) GPU and/or CPU usage may be included for intermediate KPI based performance monitoring.

In examples, the WTRU may be configured and/or determined to retain an AI/ML model in the AI engine for at least Tᵣₑₜₐᵢₙ time-units after the last inference with that AIML model. For example, the WTRU may determine a value of zero as readiness time for an AI/ML model that is last used for inference less than Tᵣₑₜₐᵢₙ time-units from the current time. For example, the time-units may be expressed as slots, symbols, milliseconds, and/or the like. The WTRU may not determine the model switching time (T_{R}=0) for an AI/ML model used for inference less than Tᵣₑₜₐᵢₙ time-units from current time. In examples, the WTRU may determine model switching time (e.g., T_{R}>0) for an AI/ML model that was not used for inference in the last Tᵣₑₜₐᵢₙ time-units from the current time based on AIML model readiness state.

Tᵣₑₜₐᵢₙ value may be determined based on the number of AIML functionalities activated, enabled, and/or triggered for a WTRU. For example, a smaller value of Tᵣₑₜₐᵢₙ may be used when the number of AIML functionalities is larger than a threshold; a lager value of Tᵣₑₜₐᵢₙ may be used when the number of AIML functionalities is smaller than and/or equal to the threshold. Tᵣₑₜₐᵢₙ value may be determined based on AI/ML model and/or AI/ML functionality. In examples, a larger value may be used and/or determined for a higher priority AI/ML model and/or AI/ML functionality. Tᵣₑₜₐᵢₙ value may be configured per AI/ML model and/or functionality. Tᵣₑₜₐᵢₙ value may be determined based on periodicity of the use of the AI/ML model and/or AI/ML functionality (e.g., periodicity of the measurement resource, UCI reporting, etc.). Tᵣₑₜₐᵢₙ value may be determined based on the required number of APUs for the associated AI/ML functionality. Tᵣₑₜₐᵢₙ value may be used as a time window and/or a timer (e.g., retain timer).

In examples, a WTRU may be configured and/or indicated with one or more uplink resources associated with an AI/ML functionality for the WTRU to report the output of the AI/ML functionality; and/or the WTRU may determine one of the uplink resources based on the readiness state of the AI/ML functionality. For example, if the AI/ML functionality is in Readiness state#0, the WTRU may determine a first uplink resource (e.g., earliest uplink resource within configured); the WTRU may determine another (e.g., second, later) uplink resource if the AI/ML functionality is in Readiness state#1 and/or #2.

The WTRU may be configured with a first CSI reporting resource and/or a second CSI reporting resource. For example, the second CSI reporting resource may occur later in time compared to the first CSI reporting resource. The WTRU may choose the first CSI reporting resource if the AI/ML model is in the AI engine. For example, the WTRU may choose the first CSI reporting resource if the AI/ML model readiness time is zero and. or lower than a threshold. The WTRU may choose the second CSI reporting resource if the AI/ML model is not in the AI engine. For example, the WTRU may choose the second CSI reporting resource if the AI/ML model readiness time is non-zero and/or higher than a threshold.

A WTRU may be configured to generate one or more (e.g., two or more) CSI reports based on the inference output of the same AI/ML model. The CSI processing time for CSI reports associated with the same AI/ML model may be a function of parallelization capability of AI/ML model. In examples, the WTRU capable of serial operation may process P CSI reports sequentially, e.g., process one CSI report at a time. For example, the WTRU may apply a first processing time to generate one CSI report from the AI/ML model and/or a second processing time to generate up to P CSI reports from the same AI/ML model. The first processing time may be smaller than the second processing time. The second processing time may be equal to P * first processing time+delta. In examples, the WTRU capable of parallelization (e.g., batch processing) may process up to P CSI reports in parallel using the same AI/ML model. For example, the WTRU may apply a third processing time to generate up to P CSI reports from the same AI/ML model. The third processing time may be equal to first processing time+a (e.g., small) delta value. For example, the value of P and/or delta may be a function of WTRU capability. If the number of CSI reports are greater than P (e.g. P+Q), for example, the WTRU may apply parallel processing for the first P reports; and/or upon completion of first P reports, for example, the WTRU may apply parallel processing for the next Q CSI reports.

In examples, the WTRU may be configured to indicate the model readiness in the applicability reporting. For example, the WTRU may indicate the applicability status (e.g., whether the WTRU side conditions are satisfied for the AI/ML model) and/or the readiness status (e.g., whether the AI/ML model is loaded in the AI engine or not). The WTRU may indicate the readiness status (e.g., only) for the applicable models.

A WTRU may have one or more AI/ML models to support an AI/ML functionality. The WTRU may switch within one or more AI/ML models to perform the associated AI/ML functionality, which may be transparent to the network. Such transparent model switch may increase the CSI computation time (T_{MIN}), which may result in larger CSI computation time than allowed processing time (T_{PROC}). When a WTRU may not finish CSI computation before occurrence of the CSI reporting resource based on model switch (e.g., T_{MIN}>T_{PROC}), for example, the WTRU may perform at least one of the following. When a WTRU may not finish CSI computation before occurrence of the CSI reporting resource based on model switch (e.g., T_{MIN}>T_{PROC}), for example, the WTRU may drop the reporting of the AI/ML functionality output (e.g., CSI report, positioning measurement report, beam reporting, etc.). When a WTRU may not finish CSI computation before occurrence of the CSI reporting resource based on model switch (e.g., T_{MIN}>T_{PROC}), for example, the WTRU may skip performing the AI/ML functionality, When a WTRU may not finish CSI computation before occurrence of the CSI reporting resource based on model switch (e.g., T_{MIN}>T_{PROC}), for example, the WTRU may transmit dummy/padding bits in the reporting of the AI/ML functionality output, which may (e.g., implicitly) indicate that WTRU skipped performing the AI/ML functionality. The dummy/padding may be based on a predetermined bit sequence. For example, one or more (e.g., all) bits may be set to 1 or 0). When a WTRU may not finish CSI computation before occurrence of the CSI reporting resource based on model switch (e.g., T_{MIN}>T_{PROC}), for example, the WTRU may delay the reporting output and/or performing of the AI/ML functionality. When a WTRU may not finish CSI computation before occurrence of the CSI reporting resource based on model switch (e.g., T_{MIN}>T_{PROC}), for example, the WTRU may indicate and/or report the reason for dropping of reporting and/or transmitting dummy/padding bits. For example, the reason may be at least one of: model switching within functionality, unavailability of APU, WTRU power status, model applicability based on WTRU side condition change(s), etc. For example, the plurality of (e.g., AI/ML) processes may include a first (e.g., AI/ML) process and/or a second (e.g., AI/ML) process. The WTRU may switch from the first (e.g., AI/ML) process to the second (e.g., AI/ML) process, for example, based on the processing unit allocation, the processing unit availability, and/or the priority order.

In examples, when T_{MIN}>T_{PROC}, a WTRU behavior (e.g., dropping, skipping, or padding) may be determined based on one or more of the following: the type of the AI/ML functionality; the configuration for the AI/ML functionality (e.g., number of antenna ports, codebook type, Set-A/B configuration for beam prediction, reporting periodicity, etc.); the priority level of the AI/ML functionality; the complexity of the AI/ML functionality (e.g., size, number of flops, required APUs, etc.); the number of AI/ML models associated with the AI/ML functionality; the AI/ML functionality identity; and/or the WTRU sided condition(s) (e.g., channel condition, power saving mode, etc.).

The CSI processing time for a WTRU may be a function of clock speed, WTRU power saving state, WTRU overheating status, etc. The WTRU may indicate as part of its capability a first processing time and/or a second processing time. The second processing time may be larger than the first processing time. The first processing time may be associated with (e.g., normal) mode of operation. For example, the first processing time may be associated with a default mode of operation, which may be associated with a default clock rate, nominal power state, and/or WTRU temperature within a (e.g., normal) range. For example, the second processing time may be associated with one or more of: slower clock speed, a low power WTRU state, a WTRU under overheating condition, etc. In examples, the WTRU may indicate as part of its capability a first processing time and/or a range of scaling factors. The scaling factors may be used to derive second processing time, a third processing time and/or the like for different levels of clock speed, power saving state, and/or overheating conditions.

The WTRU may indicate the processing time as a part of WTRU capability signaling. The WTRU may dynamically determine the processing time based on conditions not known at the network. The WTRU may report the change the minimum processing time to the network via WTRU assistance signaling (UAI), applicability reporting, RRC reconfiguration complete, MAC control element and/or L1 indication (e.g., UCI, SR, etc.).

The total required minimum processing time for AI/ML processing (T_{MIN}) may be a function of the model readiness status (T_{R}), model inference time (T_{INF}), which may be based on model size and/or complexity, time offset based on WTRU processing power (T_{OFF}), and/or one or more other factors (T_{O})-including but not limited to sub-carrier spacing (SCS), timing advance value, SCS difference between UL and DL, pre-processing, post-processing, and/or processing (e.g., needed) for CPU. For example, the required minimum processing time for AI/ML processing may be T_{MIN}=T_{R} (readiness status)+T_{INF} (Inference time)+T_{O} (others)−T_{OFF} (time offset), when the AI/ML functionality processing occupies 1 APU. The required minimum processing time may be reduced when the AI/ML functionality processing uses more than 1 APU, for example T_{MIN}=(T_{R}+T_{INF}+T_{O}−T_{OFF})×α, where α may represent a scaling factor (e.g., α=0.5 when 2 APUs are allocated), which may be determined based on the number of APUs allocated for the AI/ML. The scaling factor may be reported as a WTRU capability and/or may be based on the number of additional APUs. The scaling factor may be determined, and/or pre-defined for each AI/ML functionality. The scaling factor may be determined based on WTRU-sided condition(s).

A minimum required APUs (N_{APU,MIN}) for an A/IML functionality may be predefined, configured, reported as a WTRU capability, and/or indicated by a network, for example, when the network triggers the WTRU to perform the AI/ML functionality (e.g., aperiodic CSI reporting). When the WTRU allocates more APUs than the minimum required APUs, the minimum required processing time (T_{MIN}) may be reduced as a function of the additional APUs. A time offset value (e.g., T_{OFF}) may be determined based on the number of additional APUs and/or total number of APUs.

When a WTRU is triggered to perform inference and/or monitoring for one or more AIML functionalities, for example, the WTRU may determine APU allocation (e.g., the number of APUs occupied, and/or the time duration allocated for the occupied APUs) for each AIML functionality based on one or more of: a minimum per-functionality APU occupation; APU pool availability; a number of (e.g., simultaneous) AI/ML functionalities for which inference and/or monitoring may be performed; one or more priorities and/or processing time(s) based on number of APUs; and/or the like.

A WTRU may determine the APU allocation, for example, based on allowed processing time (e.g., T_{PROC}) indicated and/or configured by a network, to minimize the number of the dropped reports (or inference/monitoring tasks).

In examples, for a first AI/ML model/functionality, the minimum APU occupation may be N_{APU,MIN}=1. The WTRU may determine to allocate a larger number of APUs, if available in the APU pool, for example, based on a predefined timeline (if applicable), a timeline indicated by the network, and/or to minimize the dropped reports (and/or inference and/or monitoring tasks). For example, for the first AIML model/functionality, N_{APU,MIN}=1, the WTRU may select one of the following processing configurations. The WTRU may select Configuration #1: Allocated APU=1; the corresponding processing time may be T_{MIN}=T_{R}+T_{INF}+T_{O}−T_{OFF.} The WTRU may select Configuration #2: Allocated APU=2; the corresponding processing time may be T_{MIN}=(T_{R}+T_{INF}+T_{O}−T_{OFF})*0.5.

In examples, for a second AI/ML model/functionality, when the minimum APU occupation may be N_{APU,MIN}=2, the WTRU may select one of the following processing configurations. The WTRU may select Configuration #1: Allocated APU=2; the corresponding processing time may be T_{MIN}=T_{R}+T_{INF}+T_{O}−T_{OFF}. The WTRU may select Configuration #2: Allocated APU=3; the corresponding processing time may be T_{MIN}=(T_{R}+T_{INF}+T_{O}−T_{OFF})*a₁. The WTRU may select Configuration #3: Allocated APU=4; the corresponding processing time may be T_{MIN}=(T_{R}+T_{INF}+T_{O}−T_{OFF})* a₂. The WTRU may be configured to report the scaling factors (e.g., a₁, a₂).

In examples, for a third AI/ML model/functionality, when the minimum APU occupation may be N_{APU,MIN}=2, the WTRU may allocate the minimum number of APUs, and/or may report a scaling factor for the processing time as a function of WTRU-side conditions, as follows. With respect to Configuration #1: Allocated APU=2; the corresponding processing time may be T_{MIN}=(T_{R}+T_{INF}+T_{O}−T_{OFF})*b₁. With respect to Configuration #2: Allocated APU=2; the corresponding processing time may be T_{MIN}=(T_{R}+T_{INF}+T_{O}−T_{OFF})* b₂. With respect to Configuration #3: Allocated APU=2; the corresponding processing time may be T_{MIN}=(T_{R}+T_{INF}+T_{O}−T_{OFF})*b₃. Tthe scaling factors b₁, b₂, and/or b₃ may a function of WTRU-side condition(s) (e.g., clock speed, WTRU battery status). The WTRU may report the scaling factor(s).

A WTRU may report its AI/ML capabilities with one or more (e.g., multiple) options (e.g., processing time, required APUs) for the same functionality as a function of the configured reporting timeline. The WTRU may report as part of its capabilities a set of supported AI/ML models for the configured functionality. Each AI/ML model may require a certain processing time and/or number of APUs for each functionality. In examples, performance requirement(s) per functionality may be different, and/or may be a function of the timeline. For example, for a given functionality, a AI/ML model that requires less APUs may have more strict performance requirements (e.g., for providing a reasonable trade-off between complexity/latency and/or performance for a configured functionality).

A WTRU may switch the AI/ML model according to the required APUs for a functionality. For example, the WTRU may switch to a lighter (e.g., lower complexity) AI/ML model if the required APUs for a functionality is more than the unoccupied APUs. If one or more AI/ML models require the same APUs for a functionality, for example, the WTRU may select the model that, for example, consumes less battery power, and/or a model that may provide stronger (e.g., better) performance for the functionality, and/or a model that requires less processing time for the configured functionality. For example, stronger performance (e.g., for a functionality) may include using intermediate key performance indicator(s) (KPIs). KPIs may include one or more metrics to evaluate and/or characterize the performance of the AI/ML model(s) and/or functionality(ies). For example, for AI/ML based CSI prediction, a stronger performance may include stronger intermediate KPI(s). The intermediate KPIs may include one or more measurements that compare the predicted channel to the ground truth (e.g., actual channel). An example metric for intermediate KPI may include squared generalized cosine similarity (SGCS). SGCS may represent a real value between 0 and 1 (higher may be better). An example metric for intermediate KPI may include normalized mean squared error (NMSE). For example, a lower NMSE value may indicate stronger performance. A WTRU may use additional information (e.g., side information, applicable conditions) to select and/or switch to a AI/ML accordingly while performance is maximized for the given functionality.

In examples, for AI/ML-based CSI prediction use-case when the prediction window size is greater than 1 (e.g., N4>1), a WTRU may require more APUs for a functionality (e.g., inference) than in the case when N4=1. If the unoccupied APUs is less than the total required APUs for processing N4 prediction instances, for example, the WTRU may share the available APUs and/or CPUs between and/or among AI/ML and non-AI/ML methods. For example, the WTRU may perform the first prediction using a first selected AI/ML model with N4=1; the WTRU may perform one or more remaining predictions using a non-AIML method (e.g., S&H and/or Kalman) that may require a set of unoccupied CPUs (if available) when the required APUs for the remaining prediction(s) may be more than the number of unoccupied APUs.

In examples, for Joint CSI compression and prediction (JCCP) use-case, the WTRU may be equipped with two separate AI/ML models (e.g., a first model for prediction and/or a second model for compression (e.g., encoder)). For a configured functionality, the WTRU may select and/or switch to the two AI/ML models that require a total number or APUs less and/or equal than the number of unoccupied APUs. The WTRU may select the AI/ML model(s) that maximize performance while satisfying the processing time constraint according to the configured, indicated, and/or determined timeline.

When a WTRU is triggered and/or configured to perform an AI/ML functionality and/or one or more of the following conditions are met, for example, the WTRU may fall back to a non-AI/ML method for the same functionality. The one or more conditions may include: when WTRU's configured UL resources are below a configured threshold; if the configured compression ratio (e.g., of the CSI compression AIML model) is below a threshold; if the number of unoccupied APUs are above the number of required APUs by the selected and/or determined AI/ML model(s); and/or if the WTRU determines that performance of an AI/ML functionality may be compromised and/or improved using non-AIML based functionality (e.g., prediction plus AI/ML based compression (e.g., determination based on historical performance and/or based on one or more applicable condition(s)). A WTRU may free-up and/or share a set of available APUs allocated for the AI/ML functionality with another AI/ML functionality and/or another AI/ML model and/or for a different use-case and/or uses (e.g., instead a set of CPUs for the selected non-AIML based method for the non-AIML functionality for the same functionality).

A WTRU may be configured, enabled, activated, and/or triggered at least one AI/ML functionality and/or non-AI. ML functionality for the same functionality and/or use case (e.g., CSI prediction, CSI compression, positioning, beam management, channel estimation) and/or may use (e.g., either) AI/ML functionality and/or non-AIML functionality based on one or more of following.

A WTRU may use AI/ML functionality and/or non-AI/ML functionality based on the number of unoccupied APUs and unoccupied CPUs. In examples, when the number of unoccupied APUs is less than the required number of APUs for the AI/ML functionality and the number of unoccupied CPUs is larger than the required number of CPUs for the non-AIML functionality, the WTRU may determine to use non-AIML functionality. In examples, when the number of unoccupied APUs is larger than the required number of APUs for the AI/ML functionality and the number of unoccupied CPUs is less than the required number of CPUs for the non-AI/ML functionality, the WTRU may determine to use AI/ML functionality. When both the number of unoccupied APUs and the number of unoccupied CPUs is more than the required number of APUs and CPUs, for example, the WTRU may determine a default functionality. The default functionality may be predefined (e.g., AIML functionality), configured by the network, and/or determined based on the performance.

A WTRU may use AI/ML functionality and/or non-AI/ML functionality based on the WTRU-sided condition(s). The WTRU-sided condition(s) may include power saving mode, channel condition, performance level of the AI/ML functionality, WTRU speed, and/or the like. In examples, a WTRU may switch the AI/ML model for a functionality based on the battery level and/or power state. A WTRU may select the lighter (e.g., lower complexity) AI/ML model that meets the battery level and/or energy consumption constraints while maintaining performance according to the configured performance requirement(s).

A WTRU may use AI/ML functionality and/or non-AI/ML functionality based on an indication from a network (e.g. indication in a triggering control information).

A WTRU may use AI/ML functionality and/or non-AI/ML functionality based on configuration of AI/ML functionality. For example, when N4>1, and when the number of unoccupied APUs is less than those required by N4 AI/ML based prediction instances plus AI/ML based CSI compression, the WTRU may switch between AI/ML and non-AI/ML based CSI prediction, for example, if CPUs are (e.g., still) unoccupied for a set of the N4 prediction instances. In examples, a WTRU may switch to a non-AI/ML method for CSI compression if there are no constraints on the payload size of the CSI report. Based on the availability of APUs and/or CPUs, for example, a WTRU may select from different combinations based on, for the alignment with applicable condition(s), and/or the trade-off between performance and complexity/latency, and/or one or more power constraints.

A WTRU may support M APUs for processing/running one or more AIML functionalities, where M may be based on WTRU capability. The M APUs may be shared across different AI/ML functionalities. For example, the M APUs may be allocated for different AI/ML-based use-cases (e.g., CSI prediction, CSI compression, positioning, beam management, etc.). The M APUs may be shared across different models associated with a specific AI/ML functionality (and/or the same AI/ML functionality). For example, for CSI prediction with N4 prediction instances, the WTRU may allocate N4 APUs for performing inference for N4 prediction instances using N4 AI/ML models.

The number of activated AI/ML models/functionalities (e.g., N) may be greater than the number of available APUs (M). The WTRU may (e.g., need to) allocate M out of N AI/ML functionalities to share the M APU pool. The WTRU may drop N-M models and/or functionalities based on, for example, configured priority rule(s) and/or condition(s). The drop may be based on the priority across functionalities; the drop and/or priority between AI/ML models/functionalities may be determined based on one or more of the following.

The drop and/or priority between AI/ML models/functionalities may be determined based on the model size/flops; the WTRU may drop the N-M models with the highest size/flops.

The drop and/or priority between AI/ML models/functionalities may be determined based on required minimum number of APUs; the WTRU may drop the N-M models with the maximum and/or minimum number of APUs to fit in as many functionalities/models as possible. If there is more than one AIML model/functionality sharing the same minimum number of APU, for example, the WTRU may select which model/functionality to drop based on size and/or one or more (e.g., any) other configured rule(s) (e.g., fairness criteria).

The drop and/or priority between AI/ML models/functionalities may be determined based on a configured priority level; the WTRU may drop the N-M models with the configured lowest priority levels.

The drop and/or priority between AI/ML models/functionalities may be determined based on a AI/ML model functionality index number; the WTRU may drop the N-M models/functionalities with the lowest and/or highest index number(s).

The drop and/or priority between AI/ML models/functionalities may be determined based on a readiness status; the WTRU may drop the N-M functionalities with one or more configured readiness status (e.g., configured and/or available). The WTRU may (e.g., only) allocate APU resource(s) to AI/ML models/functionalities with readiness status indicated as active and/or on GPU. The WTRU may be configured to allocate the M AI/ML model functionalities with the highest readiness status; on GPU may be considered as the highest status. Other rules/conditions may be used to down-select between AI/ML functionalities with similar status.

The drop and/or priority between AI/ML models/functionalities may be determined based on a determination of periodic and/or aperiodic. For example, the WTRU may be configured to prioritize models/functionalities with aperiodic operations/runs relative to those with periodic operations. For example, the WTRU may allocate a higher priority value for functionalities with periodic reporting.

The drop and/or priority between AI/ML models/functionalities may be determined based on a performance of the model/functionality. If the WTRU is configured to run one or more (e.g., multiple) models in parallel for a specific functionality (e.g., CSI prediction with N4), for example, the WTRU may drop L<N4 models with performance less than a configured threshold. The WTRU may compare the potential relative gain of AI/ML-based functionality relative to legacy. The WTRU may drop the N-M functionalities with the lowest relative gain.

The drop and/or priority between AI/ML models/functionalities may be determined based on a determination of single-model functionalities in comparison to one or more (e.g., multiple) AI/ML models for a single functionality. The WTRU may allocate the functionalities with a single model and/or for one or more (e.g., any) remaining available APUs, the WTRU may allocate the functionalities with more than one AIML model.

The drop and/or priority between AI/ML models/functionalities may be determined based on a LCM function. The WTRU may allocate the APUs based on LCM function. For example, the WTRU may allocate APUs to functionality(ies) with inference requirement(s), performance monitoring requirement(s), and/or data collection requirement(s). For example, the WTRU may (e.g., first) allocate APUs to functionalities inference requirement(s). the WTRU may (e.g., then) allocate APUs to functionalities with performance monitoring requirement(s). The WTRU may (e.g., then) then allocate APUs to functionality(ies) with data collection requirement(s). The WTRU may use one or more (e.g., all of) the APUs for functionalities with inference requirement (e.g., first).

The drop and/or priority between AI/ML models/functionalities may be determined based on one or more priority rules. The WTRU may allocate the APU based on one or more priority rules associated with LCM function and/or the AI/ML functionality. For example, the LCM may be of higher priority than the AI/ML functionality. In examples, the AI/ML functionality may be of higher priority than the LCM function.

The drop and/or priority between AI/ML models/functionalities may be determined based on a WTRU choice. The WTRU may determine which AI/ML model/functionalities to drop.

The drop and/or priority between AI/ML models/functionalities may be determined based on a delay status. The WTRU may drop a first AIML model/functionality associated with a first delay tolerance relative to a second AIML model/functionality associated with a second delay tolerance; The first delay tolerance may be greater than the second delay tolerance.

The drop and/or priority between AI/ML models/functionalities may be determined based on an AI/ML functionality type. For example, CSI feedback related functionality may be lower priority than mobility related functionality. Demodulation (e.g., DMRS channel estimation, channel/source decoder) related AI/ML functionality may be a higher priority than non-demodulation related AI/ML.

The WTRU may be indicated to activate one or more (e.g., multiple) functionalities based on one or more requests from different entities (e.g., network entities). For example, a first entity may be a gNB and/or a second entity may be location management function (LMF) and/or user plane function (UPF) and/or access and mobility management function (AMF). A first entity functionality may have a higher priority over a second entity functionality.

For example, when a WTRU drops an AI/ML functionality for an entity based on the priority and not enough APUs are in the APU pool, the WTRU may report to the (e.g., first) entity the reason of dropping. A WTRU may report the priority of the entities, for example, when one or more (e.g., multiple) entities trigger AI/ML functionalities.

An APU pool may be divided (e.g., split) into one or more APU sub-pools. Each APU sub-pool may be associated with one or more AI/ML functionalities for the same entity. The APUs in the APU sub-pool may be used and/or occupied for the AI/ML functionalities associated with each entity. A WTRU may indicate the number of APUs in the APU sub-pool associated with the each entity, for example, when the WTRU indicates applicability of the AI/ML functionality and/or AI/ML model. A WTRU may change the number of APUs in the APU sub-pool via a higher layer signaling and/or WTRU assistance information (UAI).

A WTRU may be configured with priority rules considering cycling over functionalities with respect to fairness (e.g., to ensure fairness). For example, if the WTRU allocated APUs for a first functionality and dropped a second functionality at time t, and if the first functionality and second functionality both require APU allocation at time t+n, the WTRU may drop the first functionality (e.g., to ensure fairness across one or more functionalities). In examples, the priority rule(s) associated with the APU allocation may be based on a cell index. The primary cell may be of higher priority than a secondary cell. The UE may indicate (e.g., during applicability reporting procedure) that the WTRU has an applicable AI/ML model and/or functionality, and/or that the AI engine is fully occupied by other functionalities and/or based on WTRU memory/storage limit. When the AI engine becomes available, for example, the WTRU may provide assistance information to indicate AI engine availability. The WTRU may send a message to the network to indicate AI engine availability. The indication may be part of WTRU assistance information (UAI) signaling, and/or it may be via a flag in an uplink control channel. Based on the message, for example, the network may switch the WTRU from a first process (e.g., non-AI/ML process) to a second process (e.g., AI/ML process) for a functionality.

For a WTRU configured with AI/ML model/functionality, the APU may be occupied for a number of OFDM symbols. The start time of an APU occupation may be determined based on one or more of the following. The start time may be associated with and/or based on the last symbol of triggering message reception (e.g., last symbol of physical downlink control channel (PDCCH)). The start time may be associated with and/or based on the last symbol of pre-processing (e.g., when pre-processing is not included in the APU occupation). The start time may be associated with and/or based on the last symbol of aperiodic measurement resource (e.g., last symbol of AP-CSIRS). For one or more (e.g., any) functionality(ies), when the functionality is triggered/enabled/activated, for example, the minimum required APU may be occupied for the functionality until deactivated.

The start time may be use-case specific. For example, in case of CSI functionality, the start time may be determined based on the defined start time for legacy (e.g., CPU occupation). For example, the start time may be associated with the earliest CSI-RS resource corresponding to periodic and/or semi-persistent CSI report. The start time may be (e.g., based on) the first symbol after the PDCCH triggering the CSI report until the last symbol of the scheduled physical uplink shared channel (PUSCH) carrying the report.

With respect to positioning functionality, the start time may be associated with and/or based on the positioning reference signal (PRS) reception. For example, the reception of a first PRS of a set of PRS may be the starting point and/or the reporting measurement may be the ending point. For AI-based receiver (e.g., AIML-based CHEST), the start time may be associated with and/or based on the start symbol of the scheduled physical downlink shared channel (PDSCH) and/or start symbol of demodulation reference signal (DM-RS) and/or the ending point may be associated with and/or based on the minimum of the first symbol of hybrid automatic repeat request (HARQ) and/or a fixed configured number. For constellation shaping, the start time may be associated with and/or based on the reception of the last DM-RS symbol. The end time may be associated with and/or based on the last symbol of PUSCH and/or physical uplink control channel (PUCCH) for the associated reporting.

APU availability may be described via one or more WTRU capability(ies). A capability may indicate support for one or more aspects/features of APU availability and/or a value (e.g., the amount of available APUs) corresponding to one or more aspects/features of APU availability. Reference to capability reporting/indication herein may interchangeably indicate (e.g., both) support for and/or a value of a WTRU capability.

A WTRU may report capability for one or more aspects of APU availability. The WTRU may have a single capability to describe one or more (e.g., all_aspects of APU availability (e.g., the amount of APUs available). The WTRU may have one or more (e.g., multiple) capabilities corresponding to one or more aspects of APU availability. For example, the WTRU may indicate support for one or more of the following: the maximum number of APUs available; the maximum number of APUs supported; the minimum number of APUs available; the minimum number of APUs supported; the expected number of APUs available; a guaranteed number of APUs (e.g., throughout the duration of the connection); the duration a number of APUs can be (e.g., assumed) available; the number of APUs required for a specific functionality/model; and/or the maximum number of functionalities which can be supported by the number of APUs.

A WTRU may report the capability of one or more of the aspects of APU availability (e.g., described herein), for example, via the WTRU capability transfer procedure. The WTRU may indicate capability and/or support via one or more of the following methods. The WTRU may indicate capability and/or support via random access (and/or use of one or more dedicated resources, use of random access preamble partitioning (e.g. a set of reserved preambles or random access occasions, radio network temporary identifiers (RNTIs), etc.). The WTRU may indicate capability and/or support via upon RRC connection establishment/resumption (e.g. Msg3 and/or Msg5). The WTRU may indicate capability and/or support via upon a request from the network (e.g., upon reception of the capability enquiry message). The WTRU may indicate capability and/or support via WTRU assistance information.

The reported APU capability(ies) may be (e.g., assumed) static and/or valid for the duration of the connection (e.g., until the WTRU is released from a connected and/or inactive RRC state, while the WTRU may be connected to a network node, etc.). The reported APU capabilities may be associated with one or more validity criterion. For example, if the associated validity criteria are not satisfied, one or more of the reported capabilities related to APU availability may no longer be (e.g., assumed as to be) able to be fulfilled by the WTRU (e.g., the WTRU may no longer support the feature and/or indicated value).

The WTRU may have a single set (e.g., one or more) validity criterion associated with one or more (e.g., all) reported capabilities associated with APU availability. Each reported capability may be associated with a different set (e.g., one or more) validity criteria.

The capability, support, and/or value of one or more aspects of APU availability may be based on and/or linked to a validity duration. A duration may be represented via, for example, a start time +duration and/or a start time and/or end time. Additionally or alternatively, (e.g., only) a duration may be provided, and/or the duration may begin upon reception and/or transmission of one or more messages (e.g., upon network reception of the reported WTRU capabilities). While the duration is ongoing, for example, the NW may determine (e.g., assume) that the associated APU capabilities are valid. Upon expiry of the duration and/or for the time after an end time, for example, the associated capabilities related to APU availability may no longer be (e.g., assumed) valid.

The capability, support, and/or value of one or more aspects of APU availability may be based on and/or linked to one or more other configurations. For example, the network may determine (e.g., assume) that the indicated capability for APU availability is valid, for example, based on the activation, state, and/or configuration of one or more of the following: the configuration of an AI/ML model and/or functionality; activation of an AI/ML model and/or functionality; availability of an AI/ML model and/or functionality; and/or the number of configured/activated/available AI/ML model(s) and/or functionality(ies).

The capability and/or support for APU availability may be based on one or more characteristics of the WTRU. For example, the capability and/or support for APU availability may be based on performance of an AI/ML model and/or functionality, WTRU speed, remaining WTRU power, WTRU processing ability, WTRU location (e.g. within a certain set of cells, using one of a set of specific beams, global positioning system (GPS) location, etc.); and/or when a particular type of service is in use (e.g. related to one or more specific network slices and/or quality of service (QoS) class identifiers (QCIs).

In examples, one or more APU(s) previously reported as available may be repurposed by the WTRU for purposes other than to support RAN-based AIML functionalities (e.g., to support higher layers such as the application layer). This may impact the previously reported APU availability, for example, semi-statically and/or temporarily. The WTRU may consider the previously reported APU availability as no longer valid, for example, based on one or more of the following: the repurposed APUs may be permanently unavailable; the repurposed APUs may be unavailable to a duration exceeding a threshold; and/or the number of repurposed APUs may exceed a threshold.

If a WTRU reports one or more capability(ies) related to APU availability, it may be determined and/or assumed that the indicated capability is no longer valid (e.g., the WTRU may not and/or cannot support the feature(s) and/or indicated value(s)) when one or more of the following may occur throughout the duration of the connection: an associated configuration is not present and/or active; the number of activated, configured, and/or available functionalities exceeds a threshold; one or more of the WTRU characteristics may not be suitable; an associated duration may have expired; and/or APUs may have been repurposed by the WTRU (e.g., to support higher layer functionality). The WTRU may indicate (e.g., subject to configuration) to the network that a previously reported capability related to APU availability is no longer valid (e.g., via a MAC CE, UCI, and/or RRC signalling). The WTRU may report the reason for why the procedure is inactive (e.g., a joint configuration is disabled, and/or the WTRU characteristics are not suitable).

A WTRU may adapt (e.g., change) one or more previously reported capabilities related to APU availability. Adaptation may occur based on, for example, one or more previously reported WTRU capabilities associated with APU availability becoming invalid (e.g., such as described above). Whether the WTRU may dynamically update capability may be based on, for example, configuration (e.g., an enable/disable indication). Dynamic update(s) of a capability may be based on a prohibit duration; upon update(s) of a capability associated with APU availability, the WTRU may not send another update while the prohibit condition is active (e.g., while a prohibit timer is running).

The WTRU may provide one or more set(s) of capabilities during the initial capability reporting, which may correspond to different APU availabilities. For example, the WTRU may provide a first set (e.g., set A) of capabilities which may correspond to the maximum number of APUs available, a second set (e.g., set B) that corresponds to the minimum number of APUs available, and/or a third set (e.g., set C) that corresponds to an average number of APUs available. For example, the WTRU may provide one or more (e.g., two) sets of capabilities where a first set of capabilities may indicate default set of capabilities and/or a second set of capabilities may be an alternative set (e.g., fallback set of capabilities). Upon (e.g., initial) capability reporting, the network may determine that the WTRU is operating according to the first set of capabilities (e.g., currently applied set of capabilities). Upon detection (e.g., by the WTRU) that the (e.g., initial) set of capabilities becomes invalid, for example, the WTRU may report (e.g., via a flag and/or bit in UCI, MAC CE, RRC, RA signaling. etc.) that it can no longer operate according to the first (e.g., current) set of capabilities and/or that the WTRU is applying the second set (e.g., indicated fallback set) of capabilities. If the WTRU indicates more than two sets of capabilities associated with APU availability, for example, the WTRU may associate each set with an identifier (e.g., an index and/or ID). Upon detection that the (e.g., initial, first) set of capabilities is no longer valid, for example, the WTRU may select a set of capabilities (e.g., among the set of capabilities previously reported to the network) and/or may indicate the revised index associated with the other (e.g., new, selected) set of capabilities.

A WTRU may indicate a change in one or more previously reported capabilities (e.g., without modifying other capabilities which may have been previously reported) and/or may provide an alternative value (e.g., amount of available APUs). In this case, for example, the network may determine that (e.g., only) the modified capability is changed, and one or more (e.g., all) other previously reported capabilities may be (e.g., assumed) valid.

The dynamic update of a capability associated with APU availability may be associated with validity conditions, for example, a validity duration. In examples, the network may determine that upon expiry of the dynamically updated capability, the capability is no longer valid (e.g., the feature may not be supported, and/or the value may no longer be assumed correct). In examples, upon expiry of the dynamically indicated value, the network may determine that the originally reported (e.g., during the initial capability reporting) is valid (e.g., once again). Such temporary modification may support temporary fluctuations in APU capability based on, for example, the temporary repurposing of APUs.

Embodiments described herein may include CPU pool sharing for AI/ML functionality(ies). An AI/ML functionality may be a function which may perform certain procedures and/or processes by using one or more AI/ML models. An AI/ML functionality may be associated with a pool of AI/ML models. The pool of AI/ML models may perform certain procedures and/or processes for the functionality. For example, each AI/ML model in the pool of AI/ML models may perform certain procedure(s). For example, for AI/ML based CSI prediction, the associated pool of AI/ML models may include: a (e.g., more, generalized, complex) model that may be applicable to one or more (e.g., a broader set) of conditions (e.g., channel conditions) and/or one or more lighter (e.g., smaller) models (e.g., one or more models that may be localized to specific geographies and/or smaller model(s) trained for a subset and/or specific channel condition(s), and/or the like). Each AI/ML prediction model (e.g., from that pool) can perform CSI prediction processing, for example. A WTRU may report the number of the associated AI/ML models for an AI/ML functionality for the functionality performed at the WTRU (e.g., AI/ML functionality with WTRU-sided AI/ML models). A WTRU may report average, minimum, maximum, and/or nominal number of AI/ML models (e.g., AI/ML models to be activated and/or processed at the same time) to be activated to perform an AI/ML functionality. The reported average, minimum, maximum, and/or nominal number of AI/ML models for the AI/ML functionality may determine required number of APUs. Additionally or alternatively, a WTRU may report required number of APUs for an AI/ML functionality, which may (e.g., implicitly) indicate the number of AI/ML models used at the same time to perform the functionality. The number of AI/ML models to be activated and/or used at the same time may be determined based on AI/ML functionality.

A WTRU may be configured, activated, enabled, and/or triggered with one or more (e.g., multiple) AI/ML functionalities for the same and/or different purposes. For example, a WTRU may be configured with one or more AI/ML functionalities. A first AIML functionality may be related to a first use case (e.g., positioning/sensing); a second AI/ML functionality may be related to a second use case (e.g., beam management), a third AI/ML functionality may be related to a third use case (e.g., CSI prediction). AI/ML functionality may be configured per frequency resource (e.g., BWP, carrier, frequency band), where a maximum number of AI/ML functionalities per frequency resource may be predefined and/or reported by a WTRU as a WTRU capability. AI/ML functionality may be configured per WTRU. A WTRU may perform one or more AI/ML functionalities (e.g., simultaneously) based on the WTRU capability, required number of APUs for one or more AI/ML functionalities, and/or one or more other conditions (e.g., capability of other process(es) associated with the AI/ML functionality) for the one or more AI/ML functionalities.

An AI/ML functionality may be interchangeably used with AI/ML model (e.g., when a single AIML model is used for an AIML functionality). An AI/ML model may perform one or more AI/ML operations (e.g., inference, data collection, performance monitoring, testing, LCM). Each AIML operation may require a number of APUs to perform the operation. The required number of APUs may be different per AI/ML operation.

CSI processing unit (CPU) may be a processing unit used to compute and/or perform a CSI process which may be requested and/or configured by a network entity (e.g., gNB, TRP, server, CSI network function). The CPU may be interchangeably used with processing unit (PU), computation unit (CU), and/or generation unit (GU). The processing unit may be referred to as CPU when it is used and/or occupied by CSI related process; the processing unit may be referred to as APU (AI/ML Processing Unit) when it is used and/or occupied by AI/ML related process. In examples, the processing unit may be referred to as Positioning Processing Unit (PPU) when it is used and/or occupied by positioning related process.

A WTRU may report and/or indicate its capability of CPU pool which may include at least one of the number of CPUs, processing speed (e.g., required processing time) of one or more of CPUs, power consumption level of one or more of CPUs, number of CPUs activated and/or deactivated, number of CPUs applicable based on WTRU power state (e.g., low power mode, normal power mode), and/or number of CPUs occupied semi-statically for one or more other purposes (e.g., hidden use case, another cell, another frequency range, etc.).

A WTRU may perform one or more CSI processes (e.g., simultaneously) based on the number of CPUs in the CPU pool the WTRU reported as its capability. The CSI process may be and/or include at least one of the following.

The CSI process may be and/or include a CSI reporting configuration which may include at least one of measurement resource configurations (e.g., CSI-RS, PRS, SSB, TRS, SRS), reporting quantity related configurations (e.g., precoding matrix indicator (PMI), rank indicator (RI), channel quality identifier (CQI), LI, layer 1 (L1) reference signal received power (L1-RSRP), CSI resource indicator (CRI)), positioning measurement reporting related configurations, and/or reporting resource related configurations (e.g., PUSCH, PUCCH).

The CSI process may be and/or include a pre-processing of AI/ML input data for inference, performance monitoring, and/or data collection. Pre-processing may include at least one of channel measurement from one or more measurement resources, decomposing of channel matrix (e.g., singular value decomposition (SVD)), transform dimension of channel matrix, and/or averaging channel matrices of different resource blocks (RBs) and/or subbands.

The CSI process may be and/or include a post-processing of AIML output data for reporting. For example, the CSI process may be and/or include a process to convert AI/ML model output to a certain format (e.g., CSI reporting format) which may be understandable by a receiver.

The CSI process may be and/or include a processing for AI/ML procedure (e.g. inference, performance monitoring, data collection).

CSI process may be interchangeably used with process, AI process, AI/ML process, functionality process, model process, and/or AI/ML inference.

CPU resources in a CPU pool may be divided and/or split into one or more CPU sub-pools. Each CPU sub-pool may be associated with one of the CSI process types. For example, a first CSI process type may use one or more CPUs from a first CPU sub-pool and/or a second CSI process type may use one or more CPUs from a second CPU sub-pool. One or more of following may apply: CPU process type and/or CPU sub-pool.

CSI process type may be determined based on whether the CSI process is associated with non-AI/ML functionality and/or AI/ML functionality. In examples, if the CSI process is used for reporting CSI quantities (e.g., PMI, CQI, RI, LI, L1-RSRP, CLI, etc.) without using AI/ML model, for example, the CSI process may be a first CSI process type (e.g., non-AI/ML CSI process). If a CSI process is used for pre-processing and/or post-processing of an AI/ML functionality for CSI reporting, for example, the CSI process may be a second CSI process type (e.g., AIML CSI process). CSI process type may be determined based on LCM mode (and/or AI/ML operation) of an AI/ML model. For example, CSI process for inference may be a first CSI process type; CSI process for performance monitoring may be a second CSI process type; and/or CSI process for data collection may be a third CSI process type.

With respect to CPU sub-pool, CPU resource split between one or more CPU sub-pools may be determined based on one or more of following: WTRU capability indication (e.g., split ratio between CPU sub-pools, number of CPUs per CPU sub-pools, etc.); a network configuration (e.g., number of CPUs per CPU sub-pool); and/or number of CPUs occupied for a first CPU sub-pool. For example, the number of CPUs for one or more CPU sub-pools may change dynamically based on the number of CPUs occupied for a first CPU sub-pool. In examples, the number CPUs for a first CPU sub-pool may be determined based on the number of CPUs occupied for a first CSI process type and/or the rest of CPUs in the CPU pool may be assigned for a second CPU sub-pool. When a (e.g., another, new) CSI process is triggered and/or activated for a first CSI process associated with the first CPU sub-pool and there is no unoccupied CPU in the CPU pool, for example, the WTRU may drop the required number of CPUs in the second CPU sub-pool for the first CSI process. A CPU sub-pool may be associated with CSI process type. A CPU sub-pool may be associated with a CSI process based on whether the CSI process is associated with non-AIML functionality and/or AIML functionality. A CPU sub-pool associated with non-AIML functionality may be referred to as CPU pool and/or a CPU sub-pool associated with AIML functionality may be referred to as APU.

When there is no unoccupied CPU within a CPU sub-pool and a CSI process associated with the CPU sub-pool is triggered, activated, and/or required, for example, a WTRU may perform one or more of following. The WTRU may drop the CSI reporting associated with the CSI process. The WTRU may report dropping of the CSI reporting associated with CSI process when there is unoccupied CPUs in another CPU sub-pool. The WTRU may send a request to use unoccupied CPUs from another CPU sub-pool. The WTRU may wait until the required number of CPUs for the CSI process becomes available in the associated CPU sub-pool and/or may start using the required number of CPUs for the CSI process if the WTRU can finish the CSI process before the reporting timeline (e.g., when the required number of CPUs for the CSI process became available before the minimum required processing time for the CSI process). Minimum required processing time may be configured, predefined, and/or reported as WTRU capability for a CSI process.

One or more CPUs may be used within a CPU pool. Each CPU within the CPU pool may be associated with a CPU type. For example, a CPU pool may include one or more CPUs and/or each CPU may be a first CPU type (e.g., Type-1 CPU) and/or a second CPU type (e.g., Type-2 CPU). Each CPU type may be used (e.g., only) for a certain process. Type-1 CPU may be used and/or can be occupied by a process associated with non-AIML functionality and/or Type-2 CPU may be used and/or can be occupied by a process associated with AIML functionality.

A process associated with non-AI/ML functionality may include one or more of: channel measurement from measurement resources (e.g., CSI-RS, SSB, TRS, PRS, SRS, DM-RS, etc.); deriving CSI quantity from channel measurement without using an AIML model (e.g., PMI, CQI, RI, LI, CRI, RSRP, SINR, CLI); generation of reporting payload (e.g., encoding, modulation, etc.); pre-processing of input data for an AIML model; and/or post-processing of output data for an AIML model.

A process associated with AIML functionality may include one or more of: an AI/ML operation including LCM (e.g., Inference, performance monitoring, data collection, test of a model); pre-processing of data for AIML model input; and/or post-processing of AIML model output to make the output data in a certain format to transfer or exchange the data to another entity (e.g., WTRU, gNB, or a network function which performs the function including LMF).

A CSI process may include and/or require one or more CPUs in a CPU pool (and/or a CPU sub-pool) based on the complexity of the CSI process. The complexity of CSI process (e.g., number of CPUs required for the CSI process) may be determined based on one or more of the following.

With respect to non-AI/ML related aspects, the complexity of CSI process may be determined based on one or more of: a number of measurement resources associated with the CSI process; a number of antenna ports associated with the measurement resource; a time window (e.g., time length) associated with the measurements and/or AIML model input; a number of time instances associated with the measurements and/or AIML model input; a codebook type used for the CSI process (e.g., Type-I, Type-II, etc.); one or more codebook configurations; reporting overhead (e.g., payload size of the CSI reporting associated with the CSI process); and/or the like.

With respect to AI/ML related aspects, the complexity of CSI process may be determined based on one or more of: AIML model/functionality use case and/or sub-use case associated with the CSI process (e.g., beam management, CSI prediction, CSI compression, positioning, etc.); AI/ML model type associated with the CSI process (e.g., one-sided model or two-sided model); AI/ML model size and/or required number of FLOPs associated with the CSI process; and/or the like.

A CPU pool may be defined, used, determined, and/or configured per CPU type. For example, a first CPU pool (and/or a first CPU sub-pool) may be used for a first CPU type and/or a second CPU pool (and/or a second CPU sub-pool) may be used for a second CPU type. Additionally or alternatively, a common CPU pool may be configured, determined, and/or used for (e.g., both) Type-1 CPUs and/or Type-2 CPUs.

An AIML functionality may include and/or require one or more CPU types and/or one or more CPUs per CPU type to perform the functionality. Since the required number of CPU types and its associated number of CPUs for each CPU type may be determined based on WTRU implementation, for example, a WTRU may report required number of CPU types and/or required number of CPUs per CPU type for an AI/ML functionality.

When a WTRU reports applicability of an AIML functionality and/or AIML model to a network entity, for example, the WTRU may report its associated number of CPU types and/or CPU numbers for the AIML functionality and/or AIML model. One or more of following may apply.

The indication and/or reporting of the required number of CPUs for an AIML functionality and/or AIML model may include one or more of the following. The indication and/or reporting of the required number of CPUs for an AIML functionality and/or AIML model may include a required number of CPUs per CPU type (or CSI process type) (e.g., {Type-1 CPU=1, Type-2 CPU=2}). The indication and/or reporting of the required number of CPUs for an AIML functionality and/or AIML model may include a time sequence of the required CPU types and/or its associated required CPU number. The indication and/or reporting of the required number of CPUs for an AIML functionality and/or AIML model may include occupation time required for each CPU type and/or order of CPU processing. For example, 1^{st} order: {Type-2 CPU=1, N1 symbols}. For example, 2^{nd} order: {Type-1 CPU=1, N2 symbols}. For example, 3^{rd} order: {Type-2 CPU=2, N3 symbols}. The indication and/or reporting of the required number of CPUs for an AIML functionality and/or AIML model may include a time gap between order of processes.

The occupation time may be defined and/or determined in terms of number of time units (e.g., OFDM symbols, slots, frame) and/or absolute time (e.g., millisecond). The occupation time and/or required number of CPUs may be determined based on one or more AIML models used within an AIML functionality. For example, a first AIML model may include and/or require a first number of CPUs and/or occupation time; a second AIML model may include and/or require a second number of CPUs and/or occupation time. A WTRU may report the required number of CPUs and/or its associated occupation time per AIML model within the functionality.

The required number of CPU types and/or CPUs for each CPU types for an AIML functionality may be pre-defined, pre-configured, and/or configured by a network entity.

Embodiments described herein may include CPU and/or APU pool sharing for one or more (e.g., multiple) carriers. A WTRU may be triggered, indicated, enabled, and/or configured to perform one or more CSI processes. Each CSI process may correspond to and/or be associated with a carrier (e.g., component carrier, cell, TRP, etc.). The CSI process associated with a carrier may be referred and/or include one or more of the following. One or more measurement resources used by the CSI process may be located within the carrier. If measurement resources for the CSI process are located in one or more (e.g., multiple) carriers, for example, the CSI process may be associated with the lowest carrier identify among the carriers including measurement resources. A WTRU reporting of the CSI process (e.g., UL transmission) may be performed within the carrier. The CSI process may be configured within the carrier and/or triggered by a signaling within the carrier.

A CPU pool may be shared across CSI processes in one or more carriers. When a WTRU is triggered to perform a CSI process and unoccupied CPUs in the CPU pool is less than the required number of CPUs for the CSI process, for example, a WTRU may drop and/or release one or more CPUs already occupied for other CSI process with lower priority, and//or the WTRU may drop reporting of the CSI process if the CSI process is a lower priority than other CSI process(es) which occupy CPUs in the CPU pool. Carrier may be interchangeably used with bandwidth part (BWP), frequency band, frequency range, and/or sub-band.

A WTRU may drop and/or release one or more CPUs already occupied for other CSI process with lower priority. The CSI process priority may be determined based on one or more of the following. The CSI process priority may be determined based on a carrier identity. For example, a CSI process with lower carrier identity and/or index may be a higher priority than a CSI process with higher carrier identity and/or index. The CSI process priority may be determined based on remaining processing time. For example, a CSI process with a longer remaining processing time (e.g., processing time required to finish the CSI process) may be a lower priority than a CSI process with a shorter remaining processing time. The CSI process priority may be determined based on a number of occupied CPUs. For example, a CSI process occupying a larger number of CPUs may be a lower priority than a CSI process occupying a smaller number of CPUs. The CSI process priority may be determined based on an associated carrier bandwidth. A CSI process for a carrier with wider bandwidth (e.g., number of RBs) may be a higher priority than CSI process for a carrier with narrower bandwidth (e.g., number of RBs). The CSI process priority may be determined based on a carrier type (e.g., primary cell (Pcell), primary secondary cell (PScell), secondary cell (Scell)). For example, a CSI process for a first carrier type (e.g., Pcell) may be a higher priority than a CSI process for a second carrier type (e.g., PScell).

A CPU pool may be divided and/or split into one or more CPU sub-pools, for example, based on the number of carriers used, triggered, and/or activated. CPUs in a CPU sub-pool may be released (e.g., reallocated to another CPU sub-pool), for example, when the state of the carrier associated with the CPU sub-pool is changed (e.g., from active to inactive and/or dormant).

Embodiments described herein may include CPU and/or APU pool sharing for cooperative WTRUs. One or more WTRUs may share CPUs and/or APUs to perform one or more AIML functionality(ies). An AIML model for a first WTRU may be deployed in an AI engine of a second WTRU. The first WTRU may provide input data to perform AI operation of the AIML model at the AI engine of the second WTRU. The output of AIML operation may be sent to the first WTRU from the second WTRU. One or more of following may apply.

A set of AIML models may be shared by a group of WTRUs which may perform an AIML functionality collaboratively.

The group of WTRUs may determine which AIML model and/or AIML functionality may be performed by which WTRU within the group. For example, among the WTRUs in the group, an anchor WTRU may be determined. The anchor WTRU may determine and/or coordinate the group of WTRUs to distribute the AIML model(s) and/or AIML functionality(ies) across the WTRUs in the group, for example, based on each WTRU's capability (e.g., number of CPUs and/or APUs).

To perform an AIML functionality, WTRUs may perform a different part of the AIML functionality process. For example, a first WTRU may perform a pre-processing of the AIML functionality; a second WTRU may perform an AIML operation (e.g., inference); a third WTRU may perform a post-processing of the AIML functionality; and/or a fourth WTRU may report the output the AIML functionality.

The minimum processing time for an AIML functionality may include data exchange time among WTRUs in the group. For example, other processing time (TO) may include data exchange time (TEX), which may be determined based on one or more of the following: a number of WTRUs in the group; distance between WTRUs for data exchange; channel quality (e.g., RSRP of a reference signal) between WTRUs; interface used (e.g., 3gpp-based interface, non-3gpp-based interface); and/or a group capability reporting. The UE group may report the capability of data exchange between WTRUs in the group in terms of time, data rate, latency, and/or the like.

Within the group of WTRUs, each WTRU may perform a part of AIML functionalities (e.g., inference) for the WTRUs in the group. The WTRU may be a WTR with AI engine and/or one or more of the rest of WTRUs may not have AI engine. AIML functionality applicability (and/or availability) may be determined based on the communication link quality (e.g., RSRP level) between the WTRU triggered for an AIML functionality and the WTRU with AI engine capability. AIML functionality applicability may be determined based on a number of unoccupied APUs and/or CPUs in the WTRU with AI engine. The WTRU with AI engine in the WTRU group may broadcast within the WTRU group, the number of unoccupied APUs and/or CPUs periodically and/or aperiodically upon request from another WTRU.

A WTRU may be indicated, configured, and/or informed by a network entity for the WTRU group associated with the WTRU. The WTRUs within the WTRU group may transmit the required data for the CSI process using an interface used between WTRUs (e.g., sidelink). The WTRU may be informed the shared CPUs from the one or more other WTRUs within the WTRU group.

1. A wireless transmit/receive unit (WTRU) comprising:
a processor configured to:
receive configuration information, wherein the configuration information indicates measurement reporting information for a plurality of processes;
determine a processing unit allocation for each process of the plurality of processes based on one or more parameters, wherein the one or more parameters comprise a minimum processing time associated with each process of the plurality of processes, or a readiness status of each process of the plurality of processes;
determine a priority order for each process of the plurality of processes based on a processing unit availability;
determine to process at least a subset of the plurality of processes based on the priority order, the processing unit availability, and the processing unit allocation for each AI/ML process of the plurality of processes; and
send a report associated with each process of the at least subset of the plurality of processes.

2. The WTRU of claim 1, wherein the one or more parameters comprise one or more of:
per-functionality artificial intelligence/machine learning (AI/ML) processing unit (APU) occupation, an indication of AI/ML model complexity, an indication of WTRU capability, a number of simultaneous AI/ML functionalities for which inference is performed, or a priority associated with an AI/ML model.

3. The WTRU of claim 1, wherein the processor is configured to:
send an indication of processing unit capability at the WTRU, wherein the processing unit capability comprises artificial intelligence/machine learning (AI/ML) processing unit (APU) capability or channel state information (CSI) processing unit (CPU) capability of the WTRU; and
wherein the processor is configured to receive the configuration information in response to the indication of the APU capability or the CPU capability.

4. The WTRU of claim 3, wherein the APU capability comprises one or more of: an APU pool type, a maximum number of APU; an indication of one or more functionality specific parameters for per-functionality APU occupation calculation; an indication of one or more parameters for minimum time for AI/ML processing calculations; or an indication of CPU pool sharing for AI/ML.

5. The WTRU of claim 1, wherein the processor is configured to determine an artificial intelligence/machine learning (AI/ML) processing unit (APU) allocation for one or more AI/ML functionalities to minimize dropped reports or inference tasks to determine the processing unit allocation.

6. The WTRU of claim 1, wherein each artificial intelligence/machine learning (AI/ML) process of the plurality of processes is associated with an AI/ML function, wherein the AI/ML function comprises one or more of: channel state information (CSI) reporting; beam management (BM) reporting; WTRU positioning measurements; sensing; AI-based receiver; or WTRU position prediction.

7. The WTRU of claim 1, wherein the processor is configured to:
determine that the plurality of processes are triggered; and
determine the processing unit availability based on the processing unit allocation for each process of the plurality processes, the minimum processing time associated with each process of the plurality of processes, a maximum number of processing units at the WTRU, or capability of the processing units at the WTRU.

8. The WTRU of claim 1, wherein the processing unit availability comprises artificial intelligence/machine learning (AI/ML) processing unit (APU) availability or channel state information (CSI) processing unit (CPU) availability.

9. The WTRU of claim 1, wherein the at least a subset of the plurality of processes isthe plurality of processes.

10. The WTRU of claim 1, wherein the plurality of processes comprises a first process and a second process, and wherein the processor is configured to switch from the first process to the second process based on the processing unit allocation, the processing unit availability, or the priority order.

11. A method performed by a wireless transmit/receive unit (WTRU), the method comprising:
receiving configuration information, wherein the configuration information indicates measurement reporting information for a plurality of processes;
determining a processing unit allocation for each process of the plurality of processes based on one or more parameters, wherein the one or more parameters comprise a minimum processing time associated with each process of the plurality of processes, or a readiness status of each process of the plurality of processes;
determining a priority order for each process of the plurality of processes based on a processing unit availability;
determining to process at least a subset of the plurality of processes based on the priority order, the processing unit availability, and the processing unit allocation for each process of the plurality of processes; and
sending a report associated with each process of the at least subset of the plurality of processes.

12. The method of claim 11, wherein the one or more parameters comprise one or more of:
per-functionality artificial intelligence/machine learning (AI/ML) processing unit (APU) occupation, an indication of AI/ML model complexity, an indication of WTRU capability, a number of simultaneous AI/ML functionalities for which inference is performed, or a priority associated with an AI/ML model.

13. The method of claim 11, further comprising:
sending an indication of processing unit capability at the WTRU, wherein the processing unit capability comprises artificial intelligence/machine learning (AI/ML) processing unit (APU) capability or channel state information (CSI) processing unit (CPU) capability of the WTRU; and
wherein the configuration information is received in response to the indication of the APU capability or the CPU capability.

14. The method of claim 13, wherein the APU capability comprises one or more of: an APU pool type, a maximum number of APU; an indication of one or more functionality specific parameters for per-functionality APU occupation calculation; an indication of one or more parameters for minimum time for AI/ML processing calculations; or an indication of CPU pool sharing for AI/ML.

15. The method of claim 11, further comprising determining an artificial intelligence/machine learning (AI/ML) processing unit (APU) allocation for one or more AI/ML functionalities to minimize dropped reports or inference tasks to determine the processing unit allocation.

16. The method of claim 11, wherein each artificial intelligence/machine learning (AI/ML) process of the plurality of processes is associated with an AI/ML function, wherein the AI/ML function comprises one or more of: channel state information (CSI) reporting; beam management (BM) reporting; WTRU positioning measurements; sensing; AI-based receiver; or WTRU position prediction.

17. The method of claim 11, further comprising:
determining that the plurality of processes are triggered; and
determining the processing unit availability based on the processing unit allocation for each process of the plurality of processes, the minimum processing time associated with each process of the plurality of processes, a maximum number of processing units at the WTRU, or capability of the processing units at the WTRU.

18. The method of claim 11, wherein the processing unit availability comprises artificial intelligence/machine learning (AI/ML) processing unit (APU) availability or channel state information (CSI) processing unit (CPU) availability.

19. The method of claim 11, wherein the at least a subset of the plurality of processes is the plurality of processes.

20. A wireless transmit/receive unit (WTRU) comprising:
a processor configured to:
receive configuration information, wherein the configuration information indicates measurement reporting information for a plurality of processes;
determine a processing unit allocation for each process of the plurality of processes based on one or more parameters, wherein the one or more parameters comprise a minimum processing time associated with each process of the plurality of processes or a readiness status of each process of the plurality of processes;
determine to process at least a subset of the plurality of processes based on the processing unit allocation for each process of the plurality of processes; and
send a report associated with each process of the at least subset of the plurality of processes.
